(19) United States
(12) Patent Application Publication
(10) Pub. No.: US 2025/0324420 A1
(43) Pub. Date: Oct. 16, 2025

(54) METHODS, ARCHITECTURES, APPARATUSES AND SYSTEMS FOR INITIAL ACCESS TO SINGLE CARRIER FREQUENCY DOMAIN EQUALIZATION (SC-FDE) SYSTEMS

(71) Applicant: InterDigital Patent Holdings, Inc., Wilmington, DE (US)

(72) Inventors: Patrick Svedman, Stockholm (SE); Tariq Elkourdi, Belleville, NJ (US); Ravikumar Pragada, Warrington, PA (US)

(21) Appl. No.: 18/634,087

(22) Filed: Apr. 12, 2024

(51) Int. Cl. H04W 72/20

(52) U.S. Cl. CPC H04W 72/20

(57) ABSTRACT

Procedures, methods, architectures, apparatuses, systems, devices, and computer program products for a single carrier frequency domain equalization (SC-FDE) synchronization framework. For example, a SC-FDE wireless communication system may support narrowband primary synchronization signals (PSSs) on a sparse raster and wideband secondary synchronization signals (SSSs) on a relatively denser raster. PSS may be transmitted in a PSS burst, and candidate SSS parameters for SSS detection may be based on a detected PSS. An SSS may be detected using the candidate SSS parameters. For example, efficient SSS detection may be provided while supporting sufficiently high numbers of cell identifiers. The presence or absence of a physical broadcast channel (PBCH) transmission may be determined based on properties of SSSs. The PSSs and SSSs may be used for cell search and initial access procedures.

### TECHNICAL FIELD

The present disclosure is generally directed to the fields of communications, software and encoding, including, for example, to methods, architectures, apparatuses, systems directed to cell search and initial access in wireless communications. More specifically, the present disclosure is directed to cell search and initial access in wireless communications using standalone single carrier frequency domain equalization (SC-FDE).

### BACKGROUND

Downlink (DL) transmission based on SC-FDE waveforms has various benefits compared to cyclic prefix orthogonal frequency-division multiplexing (CP-OFDM) waveforms. For the design of DL synchronization signals in wireless communication systems, consideration should be given to impacts on wireless transmit/receive unit (WTRU) and network power consumption, synchronization performance, and resource overhead in support of initial access procedures (e.g. cell acquisition, system information reception). A need exists to design a synchronization framework, in particular WTRU procedures, for SC-FDE DL transmission and reception considering these aspects.

### SUMMARY

In certain representative embodiments, an SC-FDE based synchronization framework may support narrowband primary synchronization signals (PSSs) on a sparse raster and wideband secondary synchronization signals (SSSs) on a dense channel and/or carrier raster. For example, PSS may be transmitted in a PSS burst that is separate from a synchronization signal/physical broadcast channel (SSS/PBCH) burst in time and/or frequency. A WTRU may determine candidate time and/or frequency locations of an SSS associated with a detected PSS.

In certain representative embodiments, a WTRU may perform detection of a SSS. The WTRU may determine a set of candidate SSS time offsets, candidate SSS center frequencies, and/or candidate SSS symbol rates and corresponding QCL relations. The WTRU may detect the SSS based on the set of SSS candidates.

In certain representative embodiments, a number of SSS hypotheses may be reduced while still supporting a high number of Cell IDs based on PSS, SSS1 and/or SSS2.

In certain representative embodiments, a WTRU may determine the presence of a PBCH in an SSS/PBCH based on the properties of a SSS (e.g., SSS1 and/or SSS2).

In certain representative embodiments, a WTRU may perform PSS detection. For example, a WTRU may receive and detect a PSS with a set of PSS parameters values (e.g., based on a synchronization frequency). Example PSS parameters include PSS symbol rate and/or PSS sequence.

In certain representative embodiments, a WTRU may determine sets of SSS parameter values. The WTRU may determine multiple sets of candidate SSS parameter values for a set of SSS parameters, based on at least the set of PSS parameter values. For example, a set of candidate SSS parameter values may comprise a SSS symbol rate, a SSS center frequency, and a PSS-to-SSS time offset. For example, a set of candidate SSS parameter values may also be associated with a QCL assumption. For example, for a first subset of the set of candidate SSS parameter values, the WTRU may assume that the candidate SSS is QCL'd with respect to time, frequency, and spatial parameters with the detected PSS. For a second subset of the set of candidate SSS parameter values, the WTRU may assume that the candidate SSS is QCL'd with respect to time and frequency parameters, but not spatial parameters, with the detected PSS.

In certain representative embodiments, a WTRU may perform SSS detection. Based on the determined sets of SSS parameter values and corresponding QCL assumptions, the WTRU may perform SSS detection and detects a first SSS, with a first set of SSS parameter values and/or a first SSS sequence ID, in a first SSS occasion.

In certain representative embodiments, a WTRU may determine of a (e.g., set of) PBCH resource(s). If the first SSS sequence ID belongs to a first set of SSS sequence IDs, the WTRU may determine a PBCH resource in the first SSS occasion (e.g., next to the detected first SSS).

Otherwise, the WTRU may determine a second SSS sequence ID that is linked to the first SSS sequence ID, such as where the second SSS sequence ID belongs to the first set of SSS sequence IDs. The WTRU performs SSS detection on one or more subsequent SSS occasions based on the first set of SSS parameter values and with the second SSS sequence Id and detects a second SSS with the first set of SSS parameter values and with the second SSS sequence Id, in a second SSS occasion. The WTRU determines a PBCH resource in the second SSS occasion (e.g., next to the detected second SSS).

For example, a set of PBCH parameter values may be determined based on the first set of SSS parameter values (e.g., the PBCH symbol rate, center frequency, or other criteria).

For example, the WTRU may determine a PCI based on the PSS and/or the SSS sequences, with the first SSS sequence ID and second SSS sequence ID corresponding to the same physical cell ID.

In certain representative embodiments, a WTRU may receive a PBCH transmission. The WTRU receives and decodes the PBCH transmission on the determined PBCH resource based on the set of PBCH parameter values. For example, based on the decoded PBCH transmission, the WTRU may receive system information, determines a resource for an UL transmission (e.g., PRACH) and send the UL transmission.

In certain representative embodiments, a WTRU may select a synchronization frequency of a wireless network using single-carrier (SC) operation (e.g., SC-FDE communications in the DL). The WTRU may determine a plurality of candidate PSS parameter sets based on the selected frequency. For example, each of the plurality of candidate PSS parameter sets may (e.g., respectively) include any of a PSS symbol rate, a PSS sequence length, a cyclic shift, a sequence identifier, a cyclic prefix length, a pulse shape, and/or a PSS periodicity. The WTRU may detect a SC-PSS using a candidate PSS parameter set of the plurality of candidate PSS parameter sets. The WTRU may determine a plurality of candidate SSS parameter sets based on the candidate PSS parameter set used to detect the SC-PSS and/or the selected synchronization frequency. For example, each of the plurality of candidate SSS parameter sets may (e.g., respectively) include any of a SSS symbol rate, a SSS center frequency, a quasi collocation (QCL) type, and/or a PSS-to-SSS time offset relative to the detected SC-PSS. The WTRU may detect a first SC-SSS using a candidate SSS parameter set of the plurality of candidate PSS parameter sets The WTRU 102 may receive a SC-PBCH transmission using the detected SC-SSS.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is time/frequency resource diagram illustrating examples of SSB-CORESET multiplexing patterns;

FIG. 3 is a diagram illustrating an example of a SC-FDE block;

FIG. 4 is a processing diagram illustrating an example of a SC-FDE transmitter and receiver;

FIG. 5 is a processing diagram illustrating an example of a SC-FDE processing flow;

FIG. 6 is a diagram illustrating an example of a SC-FDE SS with flexible bandwidth and/or sequence length;

FIG. 7 is a procedural diagram illustrating an example of a procedure to determine PSS symbol rate;

FIG. 8 is a procedural diagram illustrating another example of a procedure to determine PSS symbol rate;

FIG. 9 is a procedural diagram illustrating an example of a procedure to determine PSS symbol rate using multiple candidate PSS symbol rates;

FIG. 10 is a procedural diagram illustrating an example of a procedure using a single candidate symbol rate for PSS detection;

FIG. 11 is a bandwidth diagram illustrating examples of narrowband PSS and wideband SSS;

FIG. 12 is a procedural diagram illustrating an example of a procedure to receive a SSS using a set of candidate SSS symbol rates;

FIG. 13 is a diagram illustrating an example of associations between PSS symbol rate and candidate SSS symbol rates;

FIG. 14 is a diagram illustrating an example of associations between PSS sequences and candidate SSS symbol rates;

FIG. 15 is a procedural diagram illustrating an example of a procedure to determine a SSS symbol rate;

FIG. 16 is a procedural diagram illustrating an example of a procedure to use multiple candidate SSS symbol rates for SSS detection;

FIG. 17 is a procedural diagram illustrating an example of a procedure to use a single candidate symbol rate for SSS detection;

FIG. 18 is a bandwidth diagram illustrating examples of PSS synchronization frequencies and SSS center frequencies;

FIG. 19 is a bandwidth diagram illustrating examples of PSS and SSS frequencies and carrier configurations;

FIG. 20 is a diagram illustrating an example of a NR SSB and an example of SC-FDE PSS and SSS bursts;

FIG. 21 is a diagram illustrating an example of multiple candidate time offsets for an associated SSS;

FIG. 22 is a procedural diagram illustrating an example of a procedure to determine a SSS time-domain location;

FIG. 23 is a diagram illustrating an example of multiple candidates for SSS time offset and SSS symbol rate;

FIG. 24 is a diagram illustrating an example of multiple candidates for SSS time offset, symbol rate, and center frequency;

FIG. 25 is a diagram illustrating an example of a set of candidate SSS time offsets and symbol rates;

FIG. 26 is a diagram illustrating an example of a single PSS corresponding to multiple candidate SSS time-offsets;

FIG. 27 is a diagram illustrating examples of SSS1, PBCH and SSS2;

FIG. 28 is a diagram illustrating an example of multiple candidate SSS2 sequences which are associated with SSS1 detection;

FIG. 29 is a table diagram illustrating an example of information carried by SSS1 and SSS2 sequences;

FIG. 30 is a procedural diagram illustrating an example procedure using multiple SSS2 hypotheses;

FIG. 31 is a timing diagram illustrating an example procedure using a SSS1 sequence to determine PBCH resources;

FIG. 32 is a procedural diagram illustrating an example procedure using a SSS1 sequence to determine PBCH resources;

FIG. 33 is a procedural diagram illustrating an example procedure to determine PBCH resources based on a SSS1/SSS2 set of time domain patterns;

FIG. 34 is a diagram illustrating examples of time-domain patterns based on time separation D_{SSS} between SSS1 and SSS2 for determination of a PBCH location;

FIG. 35 is a diagram illustrating an example of determining PBCH resources based on a SSS1/SSS2 time-domain pattern;

FIG. 36 is a table diagram illustrating comparative examples of waveforms;

FIG. 37 is a time/frequency diagram illustrating a first example of NR SSB overhead;

FIG. 38 is a time/frequency diagram illustrating a second example of SC-FDE overhead;

FIG. 39 is a time/frequency diagram illustrating a third example of SC-FDE overhead;

FIG. 40 is a time/frequency diagram illustrating a fourth example of SC-FDE overhead;

FIG. 41 is a time/frequency diagram illustrating a fifth example SC-FDE overhead; and

FIG. 42 is a procedural diagram illustrating an example procedure to receive a physical broadcast channel (PBCH) transmission.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any clement thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

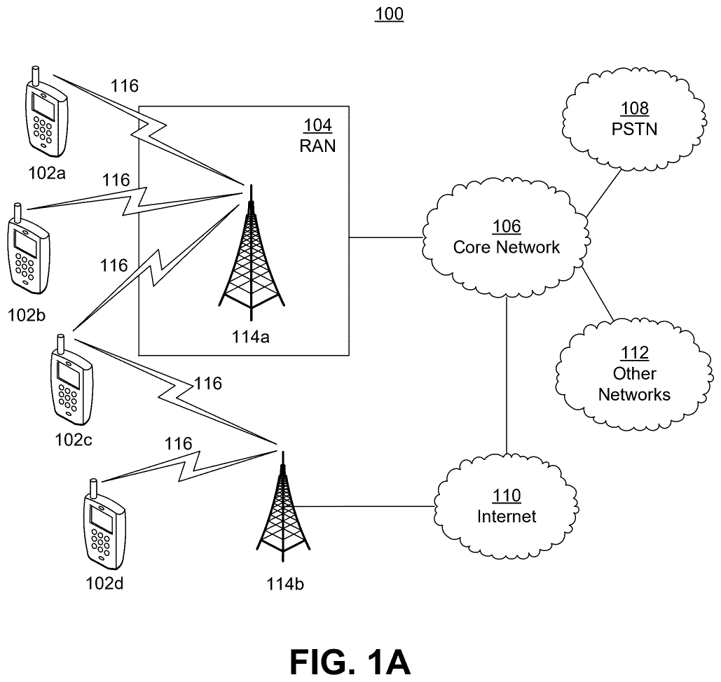

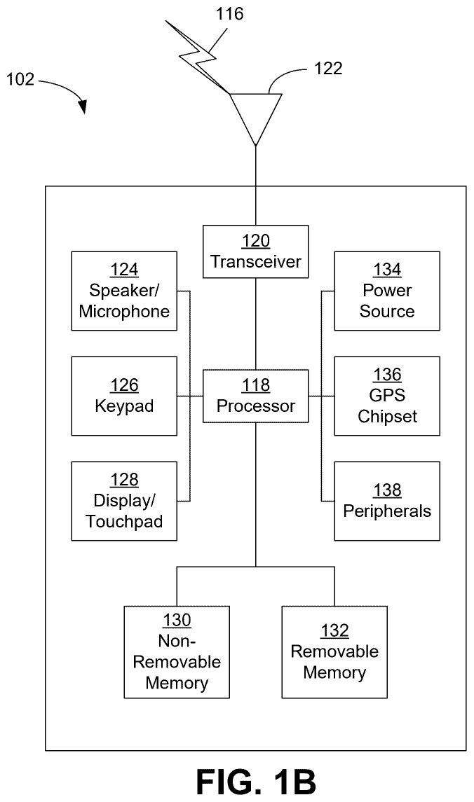

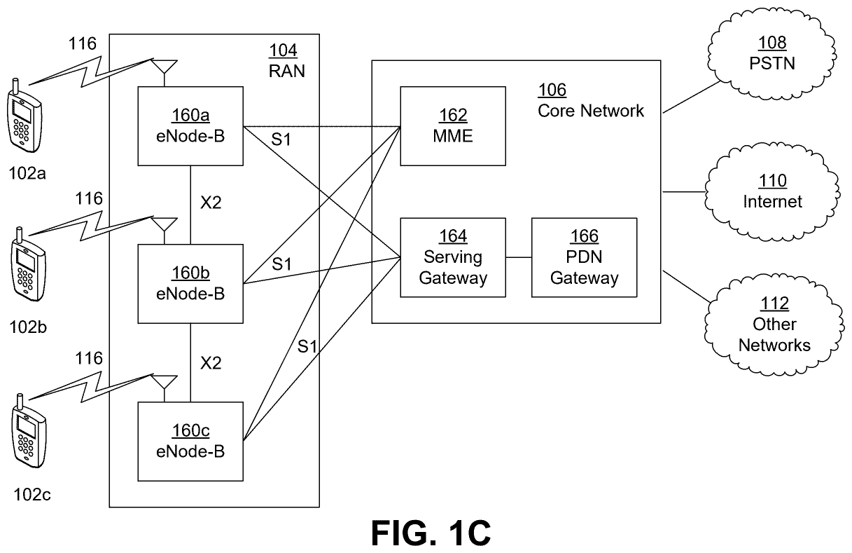

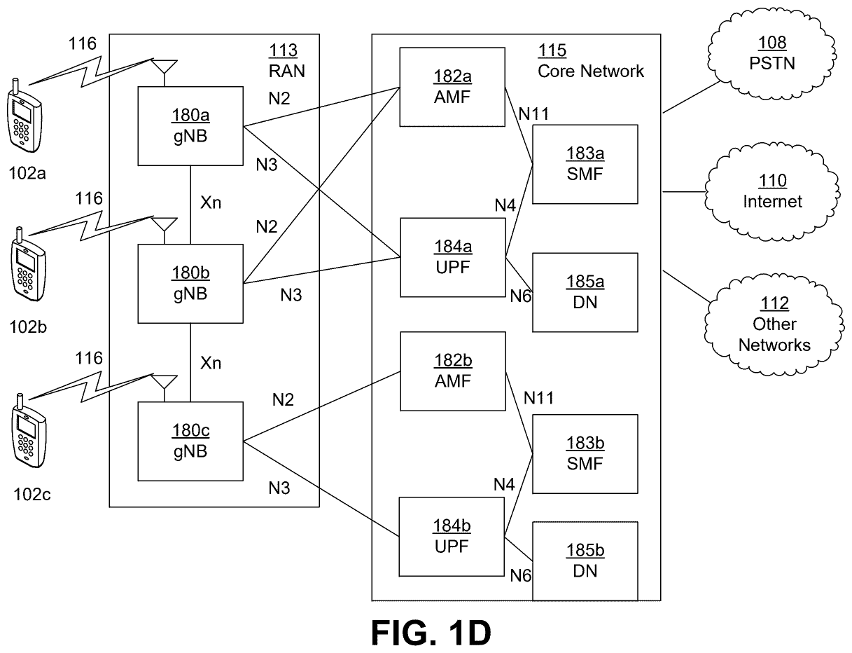

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home cNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive clement 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive clement 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive clement 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the Node-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. IC may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. ID is a system diagram illustrating the RAN 113 and the CN 115 according to an embodiment. As noted above, the RAN 113 may employ an NR radio technology to communicate with the WTRUs 102a,102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used throughout the disclosure:
ADC Analog-to-Digital Conversion
ARFCN Absolute Radio-Frequency Channel Number
BPSK Binary PSK
BW Bandwidth
CP Cyclic Prefix
CP-OFDM Conventional OFDM (relying on cyclic prefix)
CRC Cyclic Redundancy Check
CSI Channel State Information
DAC Digital-to-Analog Conversion
DCI Downlink Control Information
DFT-S Discrete Fourier Transform Spread
DL Downlink
DMRS Demodulation Reference Signal
ID Identity, Identifier, or Index
LTE Long Term Evolution, e.g. from 3GPP LTE R8 and up
MCS Modulation and Coding Scheme
MIB Master Information Block
MIMO Multiple Input Multiple Output
NR New Radio
OFDM Orthogonal Frequency-Division Multiplexing
PAPR Peak to Average Power Ratio
PBCH Physical Broadcast Channel
PCI Physical Cell ID
PDCCH Physical Downlink Control Channel
PDSCH Physical Downlink Shared Channel
PHY Physical Layer
PSK Phase Shift Keying
PSS Primary Synchronization Signal
QCL Quasi Collocation
QPSK Quadrature PSK
RF Radio Front end
RRC Radio Resource Control or Root Raised Cosine
RRM Radio Resource Management
RS Reference Signal
RSRP Reference Signal Received Power
SC-FDE Single Carrier Frequency Domain Equalization
SFN Single Frequency Network
SI System Information
SIB System Information Block
SS Synchronization Signal
SSS Secondary Synchronization Signal
TDM Time Division Multiplexing/Multiplexed
TRP Transmission/Reception Point
UL Uplink

### Synchronization Signals and Initial Access in 5G NR

In 5G NR, when a device starts initial access or decides to transition from idle and/or inactive state to connected state, it searches for SS/PBCH blocks (SSBs) which are periodically transmitted by the network. An SS/PBCH Block includes a Primary Synchronization Signal (PSS), Secondary Synchronization Signals (SSS) and a Physical Broadcast Channel (PBCH). It occupies four OFDM symbols in the time domain and 240 subcarriers in the frequency domain. The SSBs in a cell are transmitted in a time-multiplexed pattern (e.g., by transmitting different SSBs on different beams in a beam sweeping fashion). The time-multiplexed set of SSBs is sometimes referred to as an SS burst set. The SSBs in the time-multiplexed set are periodically transmitted, with a periodicity of, for example, 5, 20, or 80 ms. The maximum number of time multiplexed SSBs within an SS burst set can be up to four for frequencies below 3 GHz, or eight for frequencies between 3 GHz and 7 GHz, or 64 for frequencies above 7 GHz (e.g., FR2). Time domain locations of SSBs are different for different SSB numerologies. Each SSB carries an SSB index to indicate the relative location of the SSB to the half frame boundary. The network may transmit only a subset of all supported SSBs. The device can be informed of which SSBs are transmitted via a RRC Information Element (IE) called “ssb-PositionInBurst”.

In 5G NR, there are 3 possible PSS sequences (e.g., same as in LTE). A NR PSS is generated by using a BPSK modulated m-sequence of length 127. M-sequence is used to address time/frequency offset ambiguity problems encountered in the Zadoff-Chu sequences used in LTE. PSS is used for coarse time/frequency synchronization. PSS is also one of the factors used for determining a Physical Cell ID (PCI). A WTRU implementation may run parallel and/or sequential correlators to detect one of the 3 possible PSS sequences, with different time- and frequency offsets. If a peak if detected at a particular time/frequency, the WTRU 102 may assume which PSS that is transmitted and an SSB time/frequency offset.

There are 336 possible SSS sequences in 5G NR. After detecting PSS, at least the coarse timing and frequency of SSS is known, given that the WTRU 102 may assume that PSS and SSS are transmitted on the same antenna port. If an SSS is detected, a PCI can be calculated. The PCI is needed to demodulate PBCH. Using the PCI, the WTRU 102 can determine the frequency-domain position of DM-RS in the PBCH.

An SSB index may be provided to the WTRU 102 as two parts: an implicit part encoded in the PBCH DMRS and in the scrambling applied to the PBCH, and an explicit part included in the PBCH payload. The PBCH depends on the SSB block index. The WTRU 102 may detect which out of the (e.g., 4 or 8) possible versions of DMRS sequences that is used to determine which one was sent for a particular SSB received. The WTRU 102 may decode PBCH to obtain a Master Information Block (MIB). The MIB may carry 3 bits for the SSB index which the WTRU 102 uses, along with knowledge of which DMRS sequence was transmitted, to determine up to 64 SSB indexes (e.g., for cases of up to 64 SSBs). The MIB also contains parameters required to receive SIB1 (e.g., carried on DL-SCH) which is needed for random access. Once the SIB is decoded, the WTRU 102 has information required for a RACH procedure.

Synchronization signals may be used for any of: (i) acquisition and cell search (e.g., acquisition of frequency and symbol synchronization to a cell; acquisition of frame timing of the cell—that is determine the start of the downlink frame); (ii) determination of the physical-layer cell identity (PCI) of the cell; (iii) acquisition and demodulation of system information channels and associated DMRSs (e.g., PBCH, PDSCH for system information and associated DRMSs); (iv) acquisition and demodulation of paging information (e.g., PDSCH for paging and associated DRMRs); (v) RRM measurements in support of L3 mobility, cell search in idle mode and cell re-selection, handover in RRC connected mode, and RLM procedures; and (vi) beam management measurements (e.g., PHY measurements) in support of beam management procedures, including QCL and TCI frameworks.

For example, an acceptable cell may refer to a cell on which a WTRU 102 may camp in idle/inactive mode to obtain limited service (e.g., originate emergency calls, receive notifications from Earthquake and Tsunami Warning System (ETWS) or Commercial Mobile Alert System (CMAS), etc.). An acceptable cell fulfils a minimum set of requirements, such as not being barred, and a cell selection criterion. The cell selection criterion requires that the cell received power and cell quality are high enough.

For example, a suitable cell is a cell on which a WTRU 102 may camp in idle/inactive mode for normal service, such as to receive system information, tracking area information, registration area information, paging and notification messages, etc., from the network, as well as initiate transfer to connected mode. A suitable cell fulfils the set of requirements for an acceptable cell, as well as additional requirements, such as that the cell is a part of a mobile network that is selected or registered by the WTRU 102.

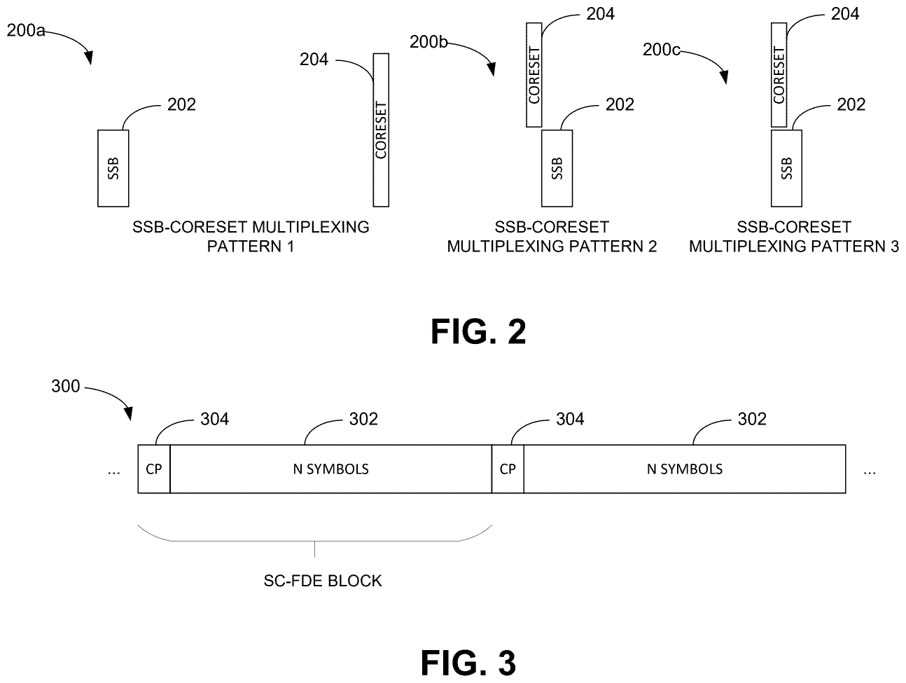

For example, upon SSB and MIB reception, a NR WTRU 102 may monitor a common CORESET (CORESET #0) for Type0-PDCCH CSS set (e.g., search space #0). FIG. 2 is time/frequency resource diagram illustrating examples of SSB-CORESET multiplexing patterns. There are three different SSB-CORESET multiplexing patterns defined, as illustrated in FIG. 2. In FIG. 2, with a SSB-CORESET multiplexing pattern 1 200a, the associated SSB 202 and CORESET 204 are time-multiplexed (e.g., in different subframes or frames). With a SSB-CORESET multiplexing pattern 2 200b, the associated SSB 202 and CORESET 204 are in the same slot, but not the same symbol. With a SSB-CORESET multiplexing pattern 3 200c, the CORESET 204 is frequency multiplexed with the associated SSB 202.

For example, the MIB includes a 4-bit configuration index for CORESET #0 and a 4-bit configuration index for search space #0. In 5G NR, the WTRU 102 determines the SSB-CORESET multiplexing pattern based on:
The 4-bit configuration index for CORESET #0,
The SSB subcarrier spacing (SCS), and
The PDCCH subcarrier spacing.

For example, if the 4-bit configuration index=5, the WTRU 102 determines the following multiplexing patterns:
SSB-CORESET multiplexing pattern 1 if SSB SCS=30 kHz and PDCCH SCS=30 kHz
SSB-CORESET multiplexing pattern 2 if SSB SCS=240 KHz and PDCCH SCS=120 kHz
SSB-CORESET multiplexing pattern 3 if SSB SCS=120 kHz and PDCCH SCS=120 kHz

In other words, the WTRU 102 cannot always determine the SSB-CORESET multiplexing pattern only based on the MIB content. The WTRU 102 determines the PDCCH subcarrier spacing based on the frequency range and a 1-bit parameter in the MIB.

### Single Carrier Frequency Domain Equalization (SC-FDE)

SC-FDE systems use a single carrier waveform that, compared to OFDM, exhibits improved PAPR characteristics, robustness to phase noise and low-resolution ADC/DAC. Although both OFDM and SC-FDE use a single DFT block and a single IDFT block (e.g., same overall complexity), the SC-FDE IDFT operation happens at the receiver. The higher power efficiency of the SC-FDE transmitter can translate into an increase in cell coverage area. Due to its single carrier nature, SC-FDE does not provide a means for frequency multiplexing (e.g., within an SC-FDE carrier) although other multiplexing means (time, space, polarization, etc.) are still applicable.

To enable frequency domain equalization using DFT/IDFT, similar to OFDM, SC-FDE systems may typically use a cyclic prefix (CP) with a duration that is longer than the channel. FIG. 3 is a diagram illustrating an example of a SC-FDE block 300. In FIG. 3, N symbols 302 plus a CP 304 are shown to form a SC-FDE block 300.

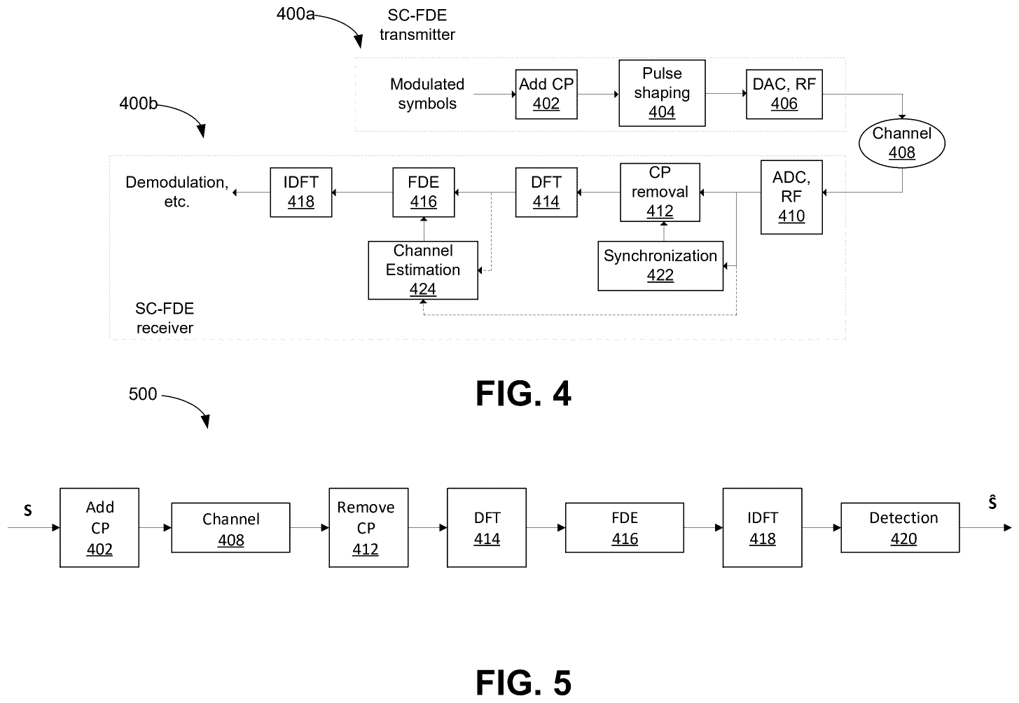

In OFDM systems, demodulation and detection are performed in the frequency domain. In SC-FDE, demodulation and detection are performed in the time domain after FDE. FIG. 4 is a processing diagram illustrating an example of a SC-FDE transmitter 400a and receiver 400b. In FIG. 4, the DFT and IDFT size should preferably match a number of symbols in a SC-FDE block 300 (e.g., N in FIG. 3). FIG. 5 is a processing diagram illustrating an example of a SC-FDE processing flow.

As illustrated in FIGS. 4 and 5, at the SC-FDE transmitter 400a, a group of Log₂M encoded data bits are mapped into a complex symbol s in an M-ary complex constellation. Then, N symbols are grouped into blocks. A cyclic prefix (CP) is added to each block at 402, by prefixing a copy of its last N_{CP} symbols. This prevents inter-block interference (IBI) but wastes bandwidth and may be energy inefficient. It introduces short term periodicity which may make the linear convolution of the channel impulse response look like a circular convolution. Circular convolution in the time domain is useful as it translates into multiplication in the frequency domain. The CP-extended blocks may be pulse shaped at 404, and are fed to a parallel to serial converter, a digital to analog converter, frequency up-convertor and a filter at 406 before it gets transmitted over a wireless channel 408. At the receiver 400b, the signal is fed to a frequency down-converter, a filter and analog-to-digital converter at 410. The output sequence of samples is grouped into blocks again. For each block, the CP is discarded at 412, and the remaining samples are sent to a DFT block at 414 for conversion to the frequency domain. Then, a frequency domain equalizer (FDE) at 416 is used to compensate for channel distortion. The output symbols are fed to an IDFT block at 418 for conversion to the time domain. Finally, a (e.g., optional) detection at 420 may output a detected symbol.

For example, in FIG. 4, synchronization at 422 may be provided between the frequency down-converter, filter and analog-to-digital converter at 410 and the CP removal at 412. Channel estimation at 424 may be performed with respect to the DFT at 414 and the FDE at 416.

SC-FDE transmitted signal bandwidth is proportional to the symbol rate. The SC-FDE block duration depends on symbol rate, assumed receiver DFT/IDFT size, and CP. The SC-FDE block duration may be given by Equation 1:

$$block duration = \frac{DFT size}{s ymbol rate} + CP duration \qquad ( 1 )$$

The CP duration should accommodate communication channel time dispersion, time synchronization errors, etc. It consists of an integer number of symbols that is less than the assumed receiver DFT/IDFT size. For a fixed CP duration (in seconds) and DFT/IDFT size, CP overhead grows with symbol rate (e.g., with shorter SC-FDE block duration).

### SC-FDE Initial Access

In certain representative embodiments, to facilitate more efficient synchronization signal frameworks for SC-FDE, the PSS and SSS may be decoupled. A more flexible (and efficient) SSS may be enabled by introducing WTRU 102 detection of SSS parameter values from candidate sets. To support more flexible deployment and transmission scenarios, the candidate sets of parameter values may be associated with different (e.g., candidate) QCL assumptions.

In certain representative embodiments, it may be beneficial to transmit the SSS more frequently than the PBCH, which means that only a subset of the SSS occasions may be accompanied by a PBCH. The WTRU 102 may determine an SSS occasion with a PBCH based on a SSS sequence identifier (ID) (e.g., index). The SSS sequence ID in occasions with a PBCH and the SSS sequence ID in occasions without a PBCH may be linked and may correspond to a same physical cell ID (PCI).

### Common Terminology

In certain representative embodiments, a WTRU 102 may perform a comparison with a threshold. In some examples, thresholds may be different. In some examples, the thresholds may be the same. A threshold may, for instance, be defined in a specification and may be specific for a synchronization frequency, frequency band, frequency range, or other parameter. In some representative embodiments, a WTRU 102 may have previously received a configuration for a threshold, such as in a system information and/or during a previous connection to the network. In some representative embodiments, a threshold may be pre-configured in the WTRU 102. In some representative embodiments, a threshold may be selected by the WTRU 102.

In certain representative embodiments, a synchronization signal may be transmitted on a certain frequency (e.g., the center frequency of the signal, and a certain signal bandwidth). In order to limit the number of center frequency candidates (e.g., hypotheses), a WTRU 102 may assume that a synchronization signal is transmitted on a frequency that belongs to a synchronization raster. A synchronization raster may be a set of frequency points (e.g., corresponding to center frequencies) that may be defined in a specification and/or configured to a WTRU 102.

In certain representative embodiments, a synchronization raster may comprise a set of frequency points for a frequency band that are uniformly or non-uniformly spaced (e.g., separated) within the band. The frequency spacing may be the same in different bands (e.g., adjacent bands) or different. A WTRU 102 may determine a set of synchronization raster points by using an equation, where the parameters in the equation may be defined in a specification and/or configured. In some representative embodiments, the WTRU 102 may determine a set of synchronization raster points from a table (e.g., that may be defined in a specification and/or configured to the WTRU 102).

In certain representative embodiments, a synchronization signal may be transmitted with a center frequency that is offset from a synchronization raster frequency, such as where the offset may be configurable and/or belong a predefined set of offsets (e.g., 1, 2, 3, or 4 offsets, potentially including offset 0).

In certain representative embodiments, the synchronization raster and synchronization raster point concepts may be used together. In certain representative embodiments, the synchronization raster and synchronization raster points may represent, more generally, a particular carrier frequency, which does not necessarily lie on a synchronization raster, for example, as represented by an ARFCN.

In certain representative embodiments, a synchronization frequency may be used herein to represent a frequency (e.g., carrier frequency) on which a WTRU 102 performs cell search, synchronization signal detection, synchronization signal based measurements, and/or synchronization among other operations. A synchronization frequency may correspond to a synchronization raster point and/or an ARFCN.

In certain representative embodiments, a WTRU 102 may perform an operation on a synchronization frequency that may include the WTRU 102 performing an operation on the synchronization frequency plus and/or minus a frequency offset (e.g., that is typically small in relation to the synchronization frequency). For example, a synchronization signal may be received slightly off the synchronization frequency due to Doppler shifts, imperfect oscillators, and the like.

In certain representative embodiments, a WTRU 102 may assume any of the following in various combinations, such as for PSS reception.

For example, one or more PSS sequences may be defined.

For example, different PSS sequences may be based on different cyclic shifts of a single sequence. Different PSS sequences may be associated with different parameter values (e.g., different index values). For example, the parameter value may be directly used to determine the cyclic shift.

For example, different PSS sequences may be generated using different initialization values, such as for a shift register or a pseudo-random sequence generator.

For example, modulated symbols may be pulse shaped using a pulse or a filter, which may be associated with one or more parameters, such as a roll off factor. The roll off factor may have a value between 0 and 1, such as where a small roll off factor may correspond to steeper roll off in the pulse frequency response, while resulting in higher peak-to-average-power ratio (PAPR), corresponding to a stricter roll-off. A larger roll off factor may correspond to a more relaxed roll-off and lower PAPR. Example pulses include raised cosine, such as the root raised cosine (RRC). For example, the WTRU 102 may use a matched filter in its receiver, where the filter may be matched to the pulse and/or filter at the transmitter (e.g., an RRC filter).

For example, a block of PSS symbols may be prepended and/or appended with a CP, a unique word (a predefined sequence of symbols), and/or zeros. In some cases, PSS symbols are not prepended and/or appended in such a way. As used herein, the term CP may be used to denote a prepended and/or appended CP, unique word, zeros, and/or similar.

For example, a PSS may comprise multiple consecutive or non-consecutive repetitions of a PSS sequence.

For example, baseband symbols, including CP if any, may be up converted and transmitted on the PSS frequency (e.g., on a synchronization raster point). The PSS symbols may be transmitted at a symbol rate (e.g., at a certain number of symbols per second). The bandwidth occupied by the PSS (e.g., the x dB bandwidth where x is for instance 3, 6, etc.), may depend on multiple factors, such as the PSS symbol rate and/or the used roll off factor.

For example, different PSSs (or PSSs, multiple PSSs, etc.) as used herein may refer to PSSs (e.g., PSS detection peaks) with any combination of different PSS sequences, different PSS synchronization frequencies, different PSS time offsets, different PSS frequency offsets, and/or different WTRU 102 Rx beams, panels and/or antennas used to receive the PSSs. As used herein, the term a PSS may refer to a PSS (e.g., PSS detection peak) with such properties.

For example, a WTRU 102 may determine that PSS detection peaks that are separated by a PSS periodicity corresponding to the same PSS (e.g., if the peaks correspond to the same PSS sequence, synchronization frequency, frequency offset, and/or WTRU 102 Rx beam, panel and/or antenna, or the like).

For example, the term SSS/PBCH is used herein and may refer to a SSS and/or PBCH.

### Principles and Observations

In SC-FDE systems, a WTRU 102 may receive the following synchronization signals (SS) in order to perform cell search: the primary synchronization signal (PSS) and secondary synchronization signal (SSS) which may comprise a first SSS sequence (SSS1) and a second SSS sequence (SSS2). Unlike in NR, the reception of these signals may not (e.g., does not necessarily) have to be in consecutive time domain resources. Also, unlike NR, the SS/PBCH blocks may not (e.g., do not necessarily) have to be confined in a half-frame duration but may be provided more flexibly in a 2⁻ⁿ, n={1,2, . . . } frame portion. For a frame portion with SS/PBCH blocks, the first block index of candidate PSS/SSS/PBCH blocks may be determined according to the symbol rate of the blocks as follows, where index 0 corresponds to the first block of the first slot in the frame portion.

Case A, B, . . . , etc.: Symbol Rate 1, 2, . . . , etc.: the first block of the candidate SS/PBCH blocks have indexes of {a₁, a₂, . . . aₘ}+14n.

Each case may have a number of sub-patterns (e.g., Case A1, Case A2, etc.), such as one sub-pattern per SC-FDE frequency band. Two cases or more might have the same SS/PBCH pattern despite different symbol rates. For example, if the symbol rate of SS/PBCH is unknown, the WTRU 102 may determine the pattern case based on pre-defined cases in a specification.

5G NR signals, such as SSB and TRS, are based on CP-OFDM. Details specific to OFDM such as sub-carrier spacing, FDM of SSS and PBCH as well as DMRS for demodulating PBCH cannot be directly translated to SC-FDE since it is a pure single carrier waveform. Therefore, a new synchronization signal design/framework is required. Some aspects to consider when designing a synchronization signal is its impact on WTRU 102 power consumption (e.g., due to electronic components such as ADCs). A synchronization signal bandwidth needs to take both minimum channel bandwidths and different WTRU 102 capabilities into account. Moreover, different synchronization signal bandwidths may give different synchronization accuracy. For example, an NR SSB may provide coarse time synchronization and an NR TRS may provide fine time synchronization. Moreover, even within an SSB signal, a PSS may provide the coarse time synchronization, while a SSS may provide a finer time synchronization.

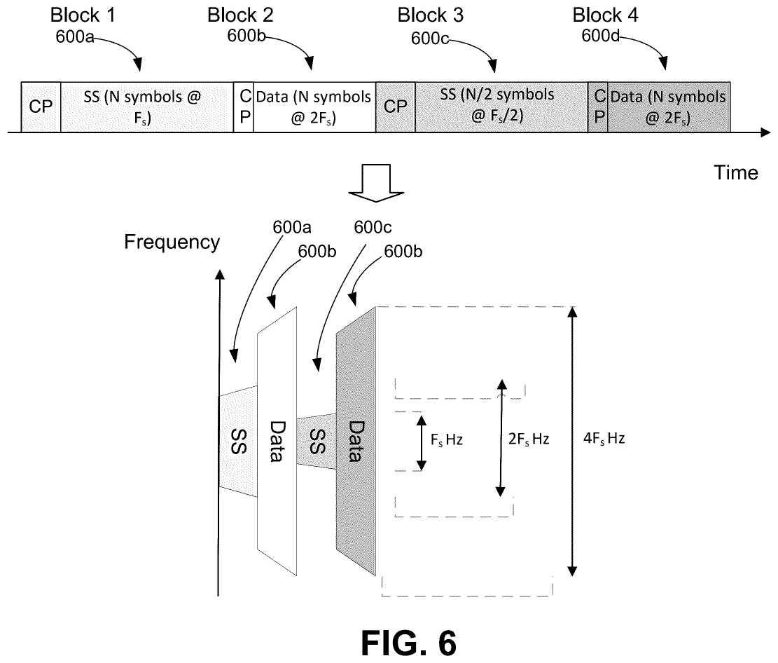

To achieve high spectrum utilization, the bandwidth of data transmissions/the data symbol rate needs to be highly flexible (e.g., configurable with a fine granularity). FIG. 6 is a diagram illustrating an example of a SC-FDE SS with flexible bandwidth and/or sequence length. A SC-FDE block may include a cyclic prefix of P symbols, and data of N symbols as shown in Block 1 600a. The symbols may be transmitted at a rate of Fₛ symbols per second and, therefore, the block duration is

$$\frac{P + N}{{F}_{s}} .$$

In the frequency domain, the SS signal bandwidth is approximately equal to 2Fₛ, where the factor 2 comes from the pulse shaping filter parameters (e.g., RRC roll off factor). Here, N data symbols may be transmitted in Block 2 600b with half the block duration of Block 1 600a and double the symbol rate, which means that the data signal will occupy double the BW of Block 1 600a. Note that doubling the BW typically means doubling the receiver sampling rate. Also note that, the transmitter and receiver symbol rate (e.g., BW) should be aligned. This is a clear difference from the current NR CP-OFDM based design, in which the SCS should be aligned. Block 3 600c has N/2 symbols and is transmitted over the same time duration as Block 1 600a but with half the symbol rate. Block 4 has N symbols and is transmitted at double the symbol rate of Block 1 600a.

### UE Effort During PSS Search

In certain representative embodiments, a WTRU 102 may use a (e.g., sparse) synchronization raster to allow for faster initial access time and/or less cell search effort (e.g., fewer hypotheses to test). For a synchronization raster point, a significant WTRU 102 effort may be needed for PSS-based cell search.

First, before PSS detection, the frame timings of the cells on the raster point may be unknown. Furthermore, it may be unknown to the WTRU 102 which SSBs from which cells that are detectable. Hence, the WTRU 102 may need to receive samples from at least a whole SSB period (e.g., which the WTRU 102 may assume is 20 ms) and search for PSSs in all those samples, which is associated with a considerable WTRU 102 effort.

Secondly, the frequency offset (e.g., due to Doppler shift) for detectable PSS(s) transmitted by a TRP may be unknown. The WTRU 102 may move at high speed towards a first TRP, at high speed towards a second TRP, and with zero relative speed towards a third TRP. Hence, the WTRU 102 may need to perform PSS detection (e.g., in all the received samples) for various PSS frequency offset hypotheses, which further contributes to the WTRU 102 effort associated with PSS search at a synchronization raster point.

In certain representative embodiments, a WTRU 102 may use different algorithms of frequency and time offset estimation and/or correction (e.g., for which the details were not specified in 3GPP standards). For example, the two most prominent algorithms depend on cross-correlation and auto-correlation methods. In the cross-correlation algorithms using PSS, the received signal is correlated with known patterns stored at the WTRU 102. This algorithm is more efficient for small frequency offset values (e.g., Fractional Frequency Offset (FFO)). The auto-correlation algorithm using CP auto-correlates the received signal with the corresponding CP part. The accuracy of this method can be improved by averaging the estimate of the frequency and/or time offsets over many OFDM symbols. For a large carrier frequency offset (CFO), the FF) may be estimated using the auto correlation method and an Integer Frequency Offset (IFO) is obtained by evaluating the shift of the received PSS. After the detection of the first PSS, subsequent PSSs may be transmitted periodically within each SSB transmission.

### UE Effort During SSS Search

In NR, since SSS occupies the third OFDM symbol of the SSB block, the WTRU 102 is able to identify SSS timing right after the detection of the first PSS. Periodic SSS transmissions are aligned with SSB timing (e.g., occur with the same periodicity). The WTRU 102 uses the same frequency filter for PSS and SSS since both occupy the same frequency resources. Every 336 SSS sequences are associated with 1 of the 3 PSS sequences which yields a total of 1008 possible PCIs. The WTRU 102 derives a PCI group number

$${N}_{ID}^{( 1 )}$$

from the SSS and the Physical Layer identity

$${N}_{ID}^{( 2 )}$$

from the PSS according to

$${N}_{ID}^{C e l l} = 3 {N}_{ID}^{( 1 )} + {N}_{ID}^{( 2 )} ,$$

where

$${N}_{ID}^{( 1 )} ∈ \{ 0 , 1 , … , 335 \} and {N}_{ID}^{( 2 )} ∈ \{ 0 , 1 , 2 \} .$$

In general, the timing and frequency offset of SSS may be largely known upon the detection of the corresponding PSS. Therefore, the WTRU 102 effort for SSS detection, such as in terms of the number of samples the WTRU 102 needs to process, is significantly less than the WTRU 102 effort for PSS detection.

### Benefits

### Benefits of “Narrowband” PSS and Limited Number of Candidate PSS Symbol Rates

As discussed above, the WTRU 102 effort for PSS detection may be high, due to the high degree of uncertainty in the time/frequency offsets of detectable PSSs, resulting in many candidates/hypotheses. Hence, the introduction of a large number of additional candidate PSS, such as in terms of PSS symbol rate, might not be feasible. A single, or a low number of, candidate PSS symbol rates per synchronization raster point would be preferable from a WTRU 102 complexity and power consumption perspective.

In the case of multiple candidate PSS symbol rates, the network may select to use a lower PSS symbol rate (and bandwidth) if the total PSS beam sweeping time is reasonable, such as if the number of PSS beams is moderate. If the number of PSS beams is very high, the network may select a higher PSS symbol rate (and bandwidth) to keep down the PSS overhead.

If a single PSS symbol rate (and corresponding PSS bandwidth) needs to be specified for a raster point, it needs to fit within the channel and carrier bandwidth in all relevant scenarios. With narrowband PSS, the WTRU 102 power efficiency is increased as the WTRU 102 receiver in a narrowband configuration uses less power in the ADC. Moreover, the noise power will be less due to lower receiver BW which increases PSS SNR. Consequently, a relatively narrow PSS bandwidth may be suitable.

### Benefits of Wideband SSS Bandwidth and PSS/SSS Separation in Time

In 5G NR, a SSS/PBCH is repeated in the time domain (e.g., in predefined directions or beams). This beam “sweeping” process happens in what is known as a burst and is repeated periodically. The maximum number of beams is frequency dependent and typically increases with frequency. Wideband SSS/PBCH has the benefit of requiring less time for sweeping a certain number of beams, resulting in less resource overhead, considering the lack of frequency multiplexing in an SC-FDE system. Furthermore, an “SSS burst” that is compact in time results in shorter WTRU 102 measurement windows for inter-frequency measurement, resulting in higher efficiency.

In 5G NR, the SSB typically doesn't provide sufficient synchronization accuracy for the highest level of spectral efficiency (e.g., high order modulation) since it is not wideband enough. Therefore, a wideband CSI-RS for tracking (e.g., TRS) needs to be transmitted in every cell with connected WTRU 102s, resulting in additional resource overhead and power consumption. A wideband SSS could to a greater extent be used also for fine synchronization, reducing the need for an additional TRS.

With different PSS and SSS symbol rates (and bandwidths), it may be beneficial to separate PSS and SSS in time (e.g., in order to reduce the amount of symbol rate switching compared to the case with interleaved PSSs and SSSs). Instead, a number of PSS may be transmitted/received consecutively in a cell. Another benefit of separating PSS and SSS in time may be that the burst of PSS, as well as the burst of SSS, may be more compact than a burst of combined PSS and SSS. This may provide a shorter measurement time for WTRU 102s that are interested in only PSS-based or only SSS-based measurement.

### Benefits of Different PSS and SSS Center Frequencies

In 5G NR, PSS and SSS share the same center frequency. In order to reduce the PSS-based cell search effort during initial access, the SSB center frequency is constrained to the sparse synchronization raster points. The synchronization raster points are typically not at the center frequency of the channel or carrier. In OFDM and NR, this is not a problem since the SSB may be located off the center of the channel and/or carrier. A WTRU 102 that receives the whole DL carrier can still receive the off-center SSB due to the inherent FDM nature of OFDM.

A sparse synchronization raster for PSS is equally beneficial in an SC-FDE based system as in NR. However, requiring also the SSS to use the same sparse synchronization raster as the center frequency may have drawbacks. For example, if a wideband SSS is used, the carrier center frequency may be too constrained. Furthermore, if SSS/PBCH is transmitted separately from the PSS (e.g., in an SSS/PBCH burst), transmitting the wideband SSS and PBCH on the same center frequency as other channels (e.g., common PDCCH) may limit the amount of center frequency switching.

### Overview

### Standalone Access

In certain representative embodiments, such as for standalone access, a WTRU 102 may search for synchronization signals based on procedures and parameters defined in a specification. For example, the WTRU 102 may search for a PSS on a predefined synchronization raster. Furthermore, the WTRU 102 may perform blind detection of various parameters, such as PSS, SSS, and/or PBCH parameters, based on candidate values (e.g., defined in a specification) for instance using various candidate values as hypotheses during signal detection and/or decoding.

### Procedures for Determination of PSS Symbol Rate

In certain representative embodiments, it may be beneficial to support a variety of PSS symbol rates, and thereby a variety of PSS bandwidths. A set of candidate PSS symbol rates may be used (e.g., as hypotheses) in the PSS reception and detection. A PSS symbol rate may thereby be blindly detected.

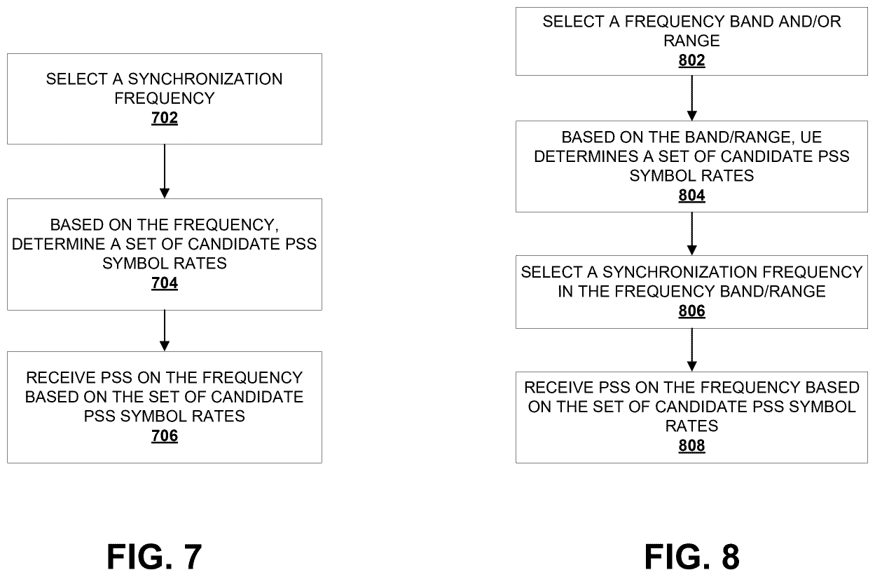

FIG. 7 is a procedural diagram illustrating an example of a procedure to determine PSS symbol rate. As shown in FIG. 7, a WTRU 102 may select a synchronization frequency at 702. Based on the selected frequency, the WTRU 102 may determine a set of candidate PSS symbol rates at 704. The set of candidate PSS symbol rates may include a single candidate PSS symbol rate, or multiple candidate PSS symbol rates. The WTRU 102 may receive the PSS based on the set of candidate PSS symbol rates at 706. In cases of a single candidate, the WTRU 102 may receive the PSS using the single PSS symbol rate. In cases of multiple candidates, the WTRU 102 may perform blind detection of the PSS symbol rate, thereby determining the PSS symbol rate.

### Determination of Candidate PSS Symbol Rates based on Synchronization Frequency

In certain representative embodiments, the determination of a set of candidate PSS symbol rates may be based on a synchronization frequency. For example, a raster point may be based on a table that lists candidate PSS symbol rates per synchronization frequency, wherein the table may be defined in a specification and/or received by the WTRU 102 in a configuration. In some cases, a configuration received by the WTRU 102 may be used to select a subset of (e.g., a single) candidate PSS symbol rates from a set of candidates that are defined in a specification.

For example, a WTRU 102 may select a subset of candidate PSS symbol rates based on the location of the synchronization frequency within the frequency band. For example, a lower band edge and a higher band edge may be defined (e.g., in a specification). The WTRU 102 may exclude candidate PSS symbol rates from a subset that corresponds to a PSS that does not fulfil radio requirements, for instance if the PSS occupied bandwidth extends beyond an edge. Different PSS roll-off factors may be assumed for different synchronization frequencies, and potentially also for different candidate symbol rates on a synchronization frequency. A stricter roll-off factor may be applicable closer to an edge, while a more relaxed roll-off factor may be assumed further from an edge.

In some embodiments, the determination of a set of candidate PSS symbol rates based on a synchronization frequency may be based on a rule that maps candidate PSS symbol rates to synchronization frequency. For example, A candidate PSS symbol rates, indexed as candidate 0 to (A-1), may be mapped to synchronization frequencies (within a set of synchronization frequencies) such that a candidate PSS symbol rate a is mapped to synchronization frequency index b if (b mod A)=a. The synchronization frequency index b may, for instance, follow a synchronization frequency indexing scheme that runs across multiple frequency ranges and bands. For example, the point indexing may run within a set of synchronization frequencies (e.g., within the set of (consecutive or non-consecutive) synchronization frequencies for the which the A candidates apply). For example, b=0 for the synchronization frequency with a lowest frequency among the set of synchronization frequencies for which the A candidates applies, b=1 for the next synchronization frequency, and so forth.

In an example with A=2, two candidate PSS symbol rates may be applicable to a particular frequency band, wherein a first candidate corresponds to candidate index a=0 (e.g., the candidate with lowest PSS symbol rate). The WTRU 102 may use the first candidate (a=0) for synchronization frequencies b for which (b mod A)=a=0 (e.g., the synchronization frequencies with even indices). Similarly, the second candidate (a=1) may be used for synchronization frequencies with odd indices.

### Determination of Candidate PSS Symbol Rates based on Frequency Band and/or Range

In certain representative embodiments, the set of candidate PSS symbol rates may be defined per frequency band and/or frequency range (e.g., which may comprise multiple frequency bands). A WTRU 102 may determine of a set of candidate PSS symbol rates based on a selected synchronization frequency that may comprise determining the frequency band and/or frequency range that the synchronization frequency belongs to and determining the set of candidate PSS symbol rates for the frequency band and/or range.

FIG. 8 is a procedural diagram illustrating another example of a procedure to determine PSS symbol rate. As shown in FIG. 8, a WTRU 102 may select a frequency band and/or frequency range at 802. Based on the selected band and/or range, the WTRU 102 may determine a set of candidate PSS symbol rates at 804. The set of candidate PSS symbol rates may comprise a single candidate PSS symbol rate, or multiple candidate PSS symbol rates. The WTRU 102 may select a synchronization frequency, such as from a set of synchronization frequencies at 806. The WTRU 102 may receive a PSS based on the set of candidate PSS symbol rates at 808. In cases of a single candidate, the WTRU 102 may receive the PSS using the single PSS symbol rate. In cases of multiple candidates, the WTRU 102 may perform blind detection of the PSS symbol rate, thereby determining the PSS symbol rate.

### Multiple PSS on a Synchronization Frequency

In certain representative embodiments, there may be multiple PSS transmitted and received on a synchronization frequency. For example, different base stations may transmit different PSS sequences. A WTRU 102 may also distinguish different PSSs by different PSS reception timings and/or different received PSS frequency offsets in relation to the synchronization frequency.

In some representative embodiments, a WTRU 102 may assume that multiple PSSs on a synchronization frequency use the same PSS symbol rate. For example, upon detection of a PSS with a PSS symbol rate (e.g., from a set of candidate PSS symbol rates) the WTRU 102 may assume that other PSSs on the frequency use the same PSS symbol rate. In other words, a WTRU 102 may use PSS detection based on multiple candidate PSS symbol rates for a first PSS and subsequently PSS detection based on a single candidate PSS symbol rate for a second PSS.

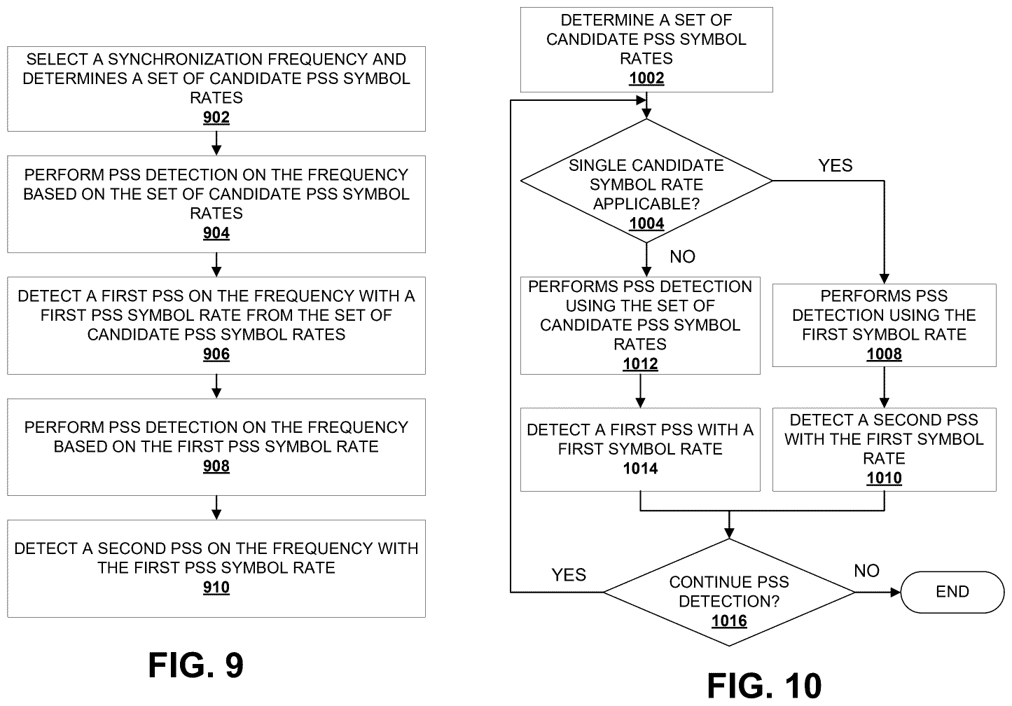

FIG. 9 is a procedural diagram illustrating an example of a procedure to determine PSS symbol rate using multiple candidate PSS symbol rates. as shown in FIG. 9, a WTRU 102 may select a synchronization frequency and determine a set of candidate PSS symbol rates at 902. The WTRU 102 may perform PSS detection on the synchronization frequency based on the set of candidate PSS symbol rates at 904. The WTRU 102 may detect a first PSS on the frequency with a first PSS symbol rate from the set of candidate PSS symbol rates at 906. The WTRU 102 may perform PSS detection on the frequency based on the first PSS symbol rate at 908. The WTRU 102 may detect a second PSS on the frequency with the first PSS symbol rate at 910.

In FIG. 9, it may be beneficial for the WTRU 102 to (e.g., need to) use the multiple candidate PSS symbol rates only for the first PSS detection. In other words, the WTRU 102 may perform PSS detection based on the multiple candidate PSS symbol rates, for example performing PSS detection based on sequentially using the candidate PSS symbol rates. The WTRU 102 may terminate PSS detection of any remaining candidate PSS symbol rates of the multiple candidate PSS symbol rates upon detection of a PSS with a first PSS symbol rate. If the WTRU 102 performs PSS detection based on a candidate PSS symbol rate of the multiple PSS symbol rate without detecting a PSS, the WTRU 102 may proceed to perform PSS detection based on a subsequent candidate PSS symbol rate in a sequence of candidate PSS symbol rates.

After the first PSS detection, and the determination of the PSS symbol rate of the first PSS, the WTRU 102 may use a single candidate PSS symbol rate for subsequent PSS detections on the synchronization frequency. The WTRU 102 may need to perform subsequent PSS detections on a synchronization frequency to detect new cells, TRPs, beams, or the like, such as to support WTRU 102 mobility and meet cell detection delay requirements. Hence, a WTRU 102 may repeatedly perform PSS detection. A WTRU 102 may perform PSS detection on a synchronization frequency, such as when camping on a cell on the synchronization frequency. A WTRU 102 may also perform PSS detection on a synchronization frequency, such as when the WTRU 102 is not camping on a cell on the synchronization frequency (e.g., if a PSS was not detected in a previous PSS detection). Even though a PSS may be detected on synchronization frequency, the WTRU 102 may try to detect other PSSs on the synchronization frequency (e.g., PSSs with different sequences and/or different time offsets) in order to be able to properly measure different cells, TRPs, beams, or the like on the synchronization frequency.

In some representative embodiments, the WTRU 102 may use the PSS symbol rate of a first detected PSS on a first synchronization frequency (e.g., a first raster point) also on other frequencies, such as for other synchronization frequencies in the same band and/or within a certain frequency offset from the frequency of the first detected PSS.

While constraining the number of candidate PSS symbol rates on a synchronization frequency may be beneficial from the WTRU 102 point of view, it may put restrictions on the network side. One way to alleviate the network side restrictions is to introduce conditions on when a WTRU 102 may assume that the symbol rate of a previously detected PSS also applies to other PSS (e.g., on the same synchronization frequency). For example, a WTRU 102 may assume that the PSS symbol rate of a first detected PSS (e.g., a first symbol rate) is applicable during a certain time (e.g., a time interval of Tess seconds, radio frames, etc.) after the reception of the first PSS. For example, the WTRU 102 may assume that the first symbol rate is applicable as long as the received power of the first detected PSS is above a threshold. These two conditions may be combined. For example, a WTRU 102 may assume that the first symbol rate may be applicable during a certain time after the reception of the first PSS and/or as long as the received power of the first PSS is above a threshold. For example, a WTRU 102 may assume the first symbol rate may be applicable as long as the received power of the first PSS is above a threshold and also during a certain time after the first reception of the first PSS for which the received power is below a threshold when, for the previous PSS reception, the received power was above the threshold. For example, a WTRU 102 may no longer assume the first symbol rate may be applicable when the received power of the first PSS is below a threshold for a certain number of consecutive PSS transmission and/or reception occasions, such as where the number of occasions may be specified or configured.

FIG. 10 is a procedural diagram illustrating an example of a procedure using a single candidate symbol rate for PSS detection. As shown in FIG. 10, a WTRU 102 may determine a set of candidate PSS symbol rates at 1002. The WTRU 102 may determine whether a single candidate symbol rate is applicable or not (e.g., as described above) at 1004. If the single candidate symbol rate is applicable for PSS detection, the WTRU 102 may perform detection using the first symbol rate at 1008. The WTRU 102 may then detect a second PSS with the first symbol rate at 1010.

If the candidate single symbol rate is not applicable at 1004, the WTRU 102 may perform PSS detection using the determined set of candidate symbol rates at 1012. For example, the WTRU 102 may detect a first PSS with the first symbol rate (e.g., of the determined set of candidate symbol rates). After detection, the WTRU 102 may determine whether or not to continue the PSS detection at 1016. For example, the procedure in FIG. 10 may be applicable to PSS detection on a synchronization frequency.

In FIG. 10, it should be noted that the “first detected PSS” or “first PSS” (used interchangeably) may not necessarily be the first PSS that the WTRU 102 detected on a synchronization frequency, but rather a label. The first PSS may, for example, be any of the latest detected PSS on the frequency, the latest detected PSS with a received power above a threshold on the frequency, and/or the detected PSS with a greatest received power on the frequency.

### Procedures for Determination of Other PSS Parameters

In certain representative embodiments, other parameters than the symbol rate may be used to define and/or determine a PSS signal. For example, parameters that may be used to define and/or determine a PSS include sequence length, sequence parameters (e.g., one or more sequence parameters may define the sequence itself, such as a cyclic shift of the sequence), sequence ID, CP duration, pulse shaping parameter(s) (e.g., roll-off factor), and/or periodicity.

In certain representative embodiments, one or more of these parameters may be predefined, such as in a specification. Other one or more of these parameters may have one or more candidate values (e.g., CP duration, periodicity, and/or sequence parameter(s)). For example, multiple candidate values may be defined in a specification.

For example, a set of candidate values for a PSS parameter (e.g., one or more of the parameters listed above) may depend on the synchronization frequency. A first frequency may be associated with a first set of candidate values, and a second point may be associated with a second set of candidate values. The first set and second set may be disjointed (e.g., non-overlapping), partly overlapping, or fully overlapping.

When searching for a PSS on a synchronization frequency, the WTRU 102 may blindly detect a PSS parameter value from the corresponding set of candidate values, such as by performing a PSS detection operation using the different candidate values (e.g., in addition to other PSS hypotheses).

In some representative embodiments, a WTRU 102 may blindly detect a PSS parameter value of a first PSS, and then apply this value to subsequent one or more PSS detections, similarly to the procedures described above for the PSS symbol rate and as illustrated in FIGS. 9 and 10.

In certain representative embodiments, a WTRU 102 may determine different PSS sequence lengths for different candidate PSS symbol rates. As an example, a longer PSS sequence length may be applicable for higher PSS symbol rates. For example, the PSS sequence length may be proportional, or roughly proportional, to the symbol rate, which means that the PSS duration is constant, or roughly constant, for different candidate PSS symbol rates. This may be beneficial since it makes the PSS time domain structure independent of the symbol rate.

In certain representative embodiments, a WTRU 102 may determine different PSS roll-off factors for different candidate PSS symbol rates. As an example, a lower PSS roll-off factor may be applicable for higher PSS symbol rates. For example, the PSS roll-off factor may be inversely proportional, or roughly inversely proportional, to the symbol rate. This may be beneficial since higher power PSS transmission may be enabled when lower symbol rates are used, at the expense of higher excess bandwidth, which may be useful in coverage-limited but not bandwidth-limited scenarios. On the other hand, lower excess bandwidth through lower roll-off factor may be more important for higher PSS symbol rates.

In some representative embodiments, a WTRU 102 may have (e.g., received) prior information regarding one or more PSS parameters. For example, a WTRU 102 may receive system information or a configuration from a cell on a first frequency (e.g., synchronization frequency) that comprises information on PSS parameter(s) on a second frequency (e.g., synchronization frequency), such as where the PSS parameter(s) may include any of the parameters discussed above (e.g., symbol rate, sequence length, periodicity, etc.).

### Procedures for Receiving and Detecting PSS

In certain representative embodiments, a WTRU 102 may perform PSS reception based on various PSS parameters. For example, a WTRU 102 receiver may use a particular sampling rate and/or receiver bandwidth that is based on a PSS symbol rate. For example, a WTRU 102 may perform reception during a time duration that corresponds to an assumption of where in time the PSS can be received. For example, a WTRU 102 may perform reception on a particular frequency that may correspond to a synchronization frequency plus a frequency offset. The PSS symbol rate, PSS time window, and PSS frequency may be examples of hypotheses (e.g., candidates) that may be applied to PSS reception.

After reception, the WTRU 102 may typically perform a PSS detection operation, in which the WTRU 102 may detect one or more PSSs. The detection operation may comprise applying various PSS parameter candidate values, such as PSS sequence, PSS time offset within a time window, PSS frequency offset in relation to a frequency, and/or PSS CP duration, or others described herein.

As an example, a WTRU 102 may apply a first set of PSS candidates (e.g., hypotheses) during reception and a second set of PSS candidates (e.g., hypotheses) during detection. The first set may be a subset of the second set. This may be beneficial since a smaller set of candidates may be used during reception than the set of candidates that may be used during detection.

For example, a WTRU 102 may use a sampling rate during reception that is based on a first set of candidate PSS symbol rates comprising a first candidate PSS symbol rate. Based on the received samples, the WTRU 102 may perform PSS detection based on a second set of candidate PSS symbol rates comprising the first candidate PSS symbol rate and a second candidate PSS symbol rate. The second candidate PSS symbol rate may be a fraction of the first candidate PSS symbol rate. PSS detection for the second candidate PSS symbol rate may comprise a down-sampling or decimation operation on the received samples. This may be beneficial since the WTRU 102 may perform reception using fewer sampling rates than candidate PSS symbol rates.

### Procedures for Determination of SSS Symbol Rate

In certain representative embodiments, a WTRU 102 may receive, detect, synchronize to, and/or measure, a PSS prior to the reception, detection, synchronization to, and/or measurement of an SSS, such as where the SSS may be associated with the PSS.

As discussed herein, it may be beneficial to support a SSS symbol rate that is different from a PSS symbol rate, such as where the PSS symbol rate may correspond to the symbol rate of a detected PSS (e.g., a PSS associated with the SSS). A set of candidate SSS symbol rates may be used as hypotheses in the SSS reception and detection. An SSS symbol rate may thereby be blindly detected.

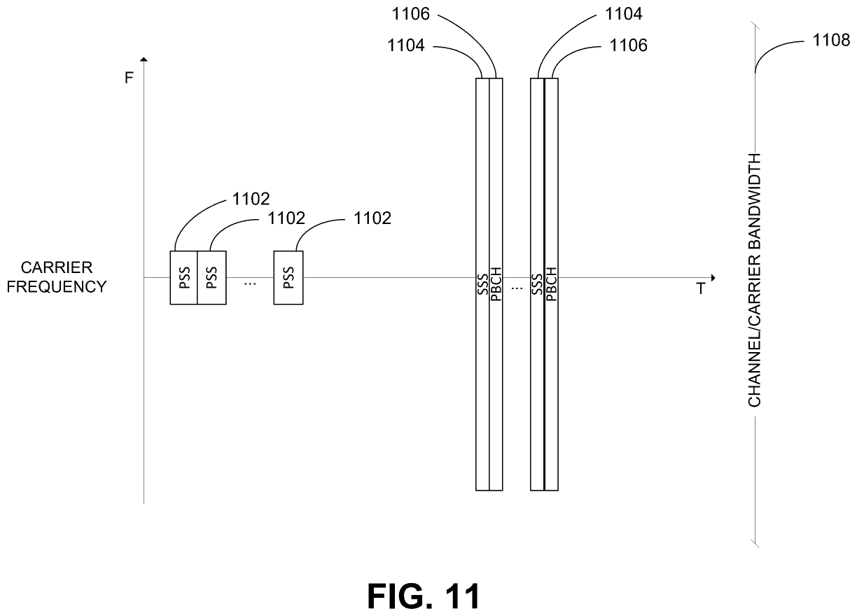

FIG. 11 is a bandwidth diagram illustrating examples of narrowband PSS and wideband SSS. In FIG. 11, a narrowband PSS 1102 may be associated with an SSS 1104 and/or PBCH 1106 with a bandwidth that is on the order of the channel and/or carrier bandwidth 1108.

In certain representative embodiments, a WTRU 102 may determine a set of candidate SSS symbol rates (e.g., for SSSs 1104) based on the synchronization frequency, which may be the frequency of a detected PSS 1102 (e.g., associated with the SSS 1104). A first set of candidates may be determined for a first frequency, while a second set of candidates may be determined for a second frequency. A set of synchronization frequencies (e.g., the frequencies in a frequency band) may be associated with a set of candidate SSS symbol rates, such as described herein for a set of candidate PSS symbol rates.

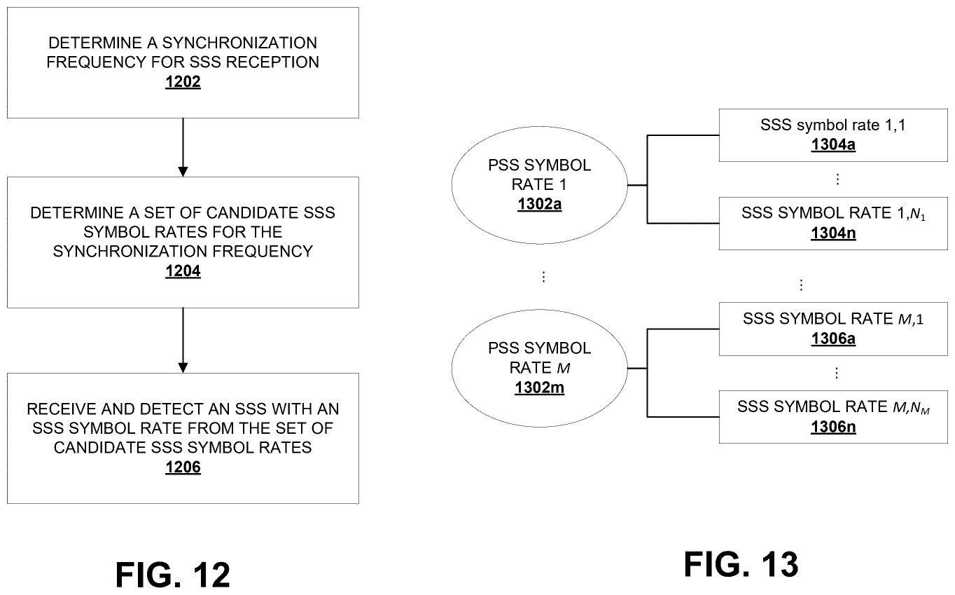

FIG. 12 is a procedural diagram illustrating an example of a procedure to receive a SSS using a set of candidate SSS symbol rates. As shown in FIG. 12, a WTRU 102 may determine a synchronization frequency for SSS reception at 1202. The determination may be based on the detection of an associated PSS (e.g., according to various methods described herein). For example, the determination may be based on a configuration of a synchronization frequency to be used for SSS reception, detection, measurement, or the like. The WTRU 102 may determine a set of candidate SSS symbol rates for the synchronization frequency at 1204. The WTRU 102 may receive and detect an SSS with a SSS symbol rate from the set of candidate SSS symbol rates (e.g., determined from the synchronization frequency) at 1206.

In some representative embodiments, a WTRU 102 may determine a set of candidate SSS symbol rates based on one or more parameters of a detected PSS (e.g., a PSS to which the SSS may be associated). For example, different candidate PSS parameter values may be associated with different sets of candidate SSS symbol rates. For example, the associations and the corresponding sets of candidate SSS symbol rates may be defined in a specification and/or configured to the WTRU 102.

FIG. 13 is a diagram illustrating an example of associations between PSS symbol rate and candidate SSS symbol rates. As shown in FIG. 13, there may be M candidate PSS symbol rates 1302a to 1302m (e.g., M=1, 2, 3, or 4). A PSS symbol rate m (m=1, . . . , M) may be associated with a set of Nm candidate SSS symbol rates. In some cases, the number of candidate SSS symbol rates may be the same for different m (e.g., Nₘ₁=Nₘ₂ at least for some m1≠m2, such as for all m1 and m2 in {1, . . . , M} with m1≠m2). Note that even though the number of candidate SSS symbol rates may be the same in two sets, the candidate SSS symbol rates may be different. In some cases, the number of candidate SSS symbol rates may be different for different m (e.g., Nₘ₁+Nₘ₂ at least for some m1≠m2, such as for all m1 and m2 in {1, . . . , M} with m1≠m2). The number of candidate SSS symbol rates (e.g., Nₘ) may be 1, 2, 3, 4, or more. In FIG. 13, the PSS symbol rate 1 1302a may be associated with a set of SSS symbol rates 1304a to 1304n, and the PSS symbol rate M 1302m may be associated with a set of SSS symbol rates 1306a to 1306n.

For example, 1 first PSS symbol rate may be associated with a set of lower candidate SSS symbol rates, while a second PSS symbol rate (e.g., lower than the first PSS symbol rate m) may be associated with a set of candidate SSS symbol rates that are higher than the lower candidate SSS symbol rates. The different sets of candidate SSS symbol rates that are associated with different PSS symbol rates may be disjoint or overlapping, such as partly overlapping. In some cases, a set of PSS symbol rates may be associated with the same set of candidate SSS symbol rates. Different sets of PSS symbol rates may be associated with different sets of candidate SSS symbol rates. A benefit of associating different PSS symbol rates with different sets of candidate SSS symbol rates is that the number of candidate SSS symbol rates upon detection of a PSS symbol rate can be kept smaller, while the system still supports a larger set of candidate SSS symbol rates overall. It may be beneficial to associate lower SSS symbol rates with a lower PSS symbol rate, such as when lower symbol rates may be beneficial in a first scenario, while higher symbol rates may be beneficial in another scenario.

In some representative embodiments, the PSS symbol rate may be among the associated candidate SSS symbol rates. In some representative embodiments, the PSS symbol rate may not be among the associated candidate SSS symbol rates.

In some representative embodiments, the set of SSS symbol rates associated with a PSS symbol rate may (e.g., also) depend on the synchronization frequency. The association(s) and set(s) illustrated in FIG. 13 may, for example, be specific to the synchronization frequency on which the PSS was detected.

In some representative embodiments, the lowest candidate SSS symbol rate in a set of candidate SSS symbol rates associated with a PSS symbol rate may be equal to the PSS symbol rate. In some representative embodiments, the candidate SSS symbol rates in a set of candidate SSS symbol rates associated with a PSS symbol rate may be integer multiples of the PSS symbol rate, such as any of 1, 2, 4, 8, 12, and/or 16. In some representative embodiments, a set of candidate SSS symbol rates associated with a PSS symbol rate may not include the PSS symbol rate.

In certain representative embodiments, a WTRU 102 may determine a set of candidate SSS symbol rates based on one or more PSS parameters of the detected PSS, such as any of the parameters described herein (e.g., PSS length, cyclic shift of PSS sequence, PSS sequence ID).

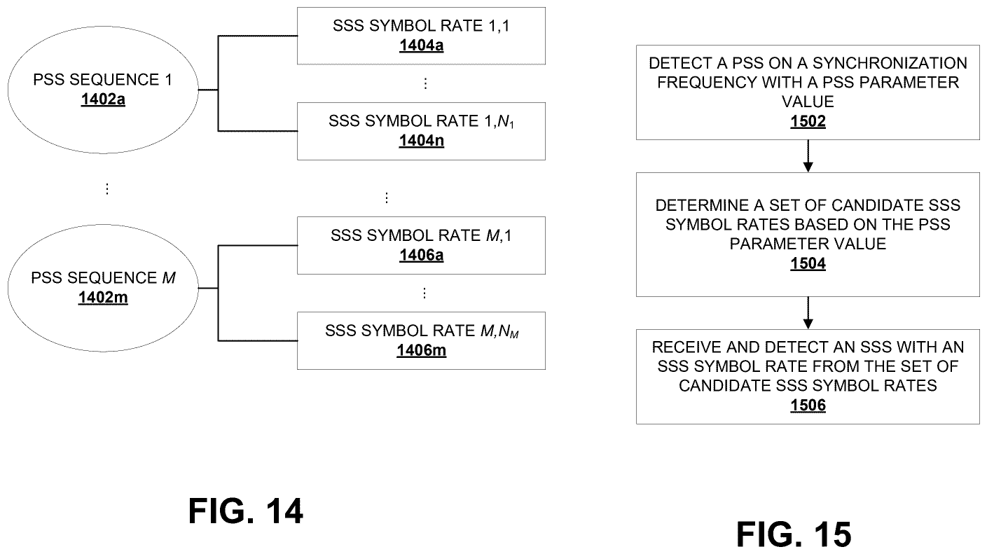

FIG. 14 is a diagram illustrating an example of associations between PSS sequences and candidate SSS symbol rates.

As shown in FIG. 14, a first PSS sequence 1402a may be associated with a set of candidate SSS symbol rates 1404a to 1404n, while a second PSS sequence 1402m may be associated with a set of candidate SSS symbol rates 1406a to 1406m (e.g., that are higher than the lower candidate SSS symbol rates). The different sets of candidate SSS symbol rates that are associated with different PSS sequences may be disjoint or overlapping (e.g., partly overlapping). In some representative embodiments, a set of PSS sequences may be associated with the same set of candidate SSS symbol rates. Different sets of PSS sequences may be associated with different sets of candidate SSS symbol rates. A benefit of associating different PSS sequences with different sets of candidate SSS symbol rates is that the number of candidate SSS symbol rates upon detection of a PSS sequence can be kept smaller, while the system may (e.g., still) support a larger set of candidate SSS symbol rates overall.

FIG. 15 is a procedural diagram illustrating an example of a procedure to determine a SSS symbol rate. As shown in FIG. 15, a WTRU 102 may detect a PSS on a synchronization frequency with a PSS parameter value at 1502, such as based on PSS parameters described herein. The WTRU 102 may determine a set of candidate SSS symbol rates based on the PSS parameter value at 1504. The WTRU 102 may receive and detect an SSS with an SSS symbol rate from the set of candidate SSS symbol rates at 1506.

In some representative embodiments, the WTRU 102 may determine the set of candidate SSS symbol rates based on the PSS symbol rate, such as described herein. In some representative embodiments, the WTRU 102 may determine the set of candidate SSS symbol rates based on the PSS sequence (e.g., a detected cyclic shift (value) applied to a PSS sequence). In some representative embodiments, the WTRU 102 may determine the set of candidate SSS symbol rates based on the PSS CP duration (e.g., which the WTRU 102 may detect). In some representative embodiments, the determination may be based on a combination of one or more PSS parameter values (e.g., the combination of PSS symbol rate and PSS sequence). In some representative embodiments, the WTRU 102 may determine the set of candidate SSS symbol rates (e.g., further) based on synchronization frequency.

In certain representative embodiments, a candidate SSS symbol rate may be associated with other candidate SSS parameters, such as a candidate SSS center frequency, a candidate SSS time domain location, a candidate SSS RRC filter roll-off factor, and the like. For example, a smaller candidate SSS symbol rate may be associated with a pulse shaping that is less steep in frequency (e.g., a higher roll off factor), while a larger candidate SSS symbol rate may be associated with a more steep pulse shaping (e.g., a lower roll off factor). This may be beneficial, such as where a lower SSS symbol rate may be associated with a higher frequency margin to out of band frequencies.

In certain representative embodiments, a first candidate SSS symbol rate may be associated with a first candidate SSS time domain location, while a second candidate SSS symbol rate may be associated with a second candidate SSS time domain location. For instance, the first candidate SSS symbol rate may be equal to the PSS symbol rate and the first SSS time domain location may be the SSS time domain location among the candidate SSS time domain locations that comes first after the PSS time domain location. This may be beneficial since the WTRU 102 might not need to change its sampling rate between the PSS reception and the reception of the first candidate SSS time domain location.

In certain representative embodiments, a first candidate SSS center frequency may be associated with a first candidate SSS time domain location, while a second candidate SSS center frequency may be associated with a second candidate SSS time domain location. For instance, the first candidate SSS center frequency may be equal to the PSS center frequency and the first SSS time domain location may be the SSS time domain location among the candidate SSS time domain locations that comes first after the PSS time domain location. This may be beneficial since the WTRU 102 might not need to change its receiver center frequency between the PSS reception and the reception of the first candidate SSS time domain location.

In certain representative embodiments, there may be multiple SSSs transmitted and received on a frequency (e.g., a synchronization frequency or a frequency associated with a synchronization frequency). For example, different base stations may transmit different SSS sequences. A WTRU 102 may (e.g., also) distinguish different SSSs by different SSS reception timings and/or different received SSS frequency offsets in relation to the synchronization frequency.

In some representative embodiments, a WTRU 102 may assume that multiple SSSs on a frequency use the same SSS symbol rate. For example, upon detection of an SSS with an SSS symbol rate (e.g., from a set of candidate SSS symbol rates), the WTRU 102 may assume that other SSSs on the frequency use the same SSS symbol rate. In other words, a WTRU 102 may use SSS detection based on multiple candidate SSS symbol rates for a first SSS and subsequent SSS detection may be based on a single candidate SSS symbol rate for a second SSS.

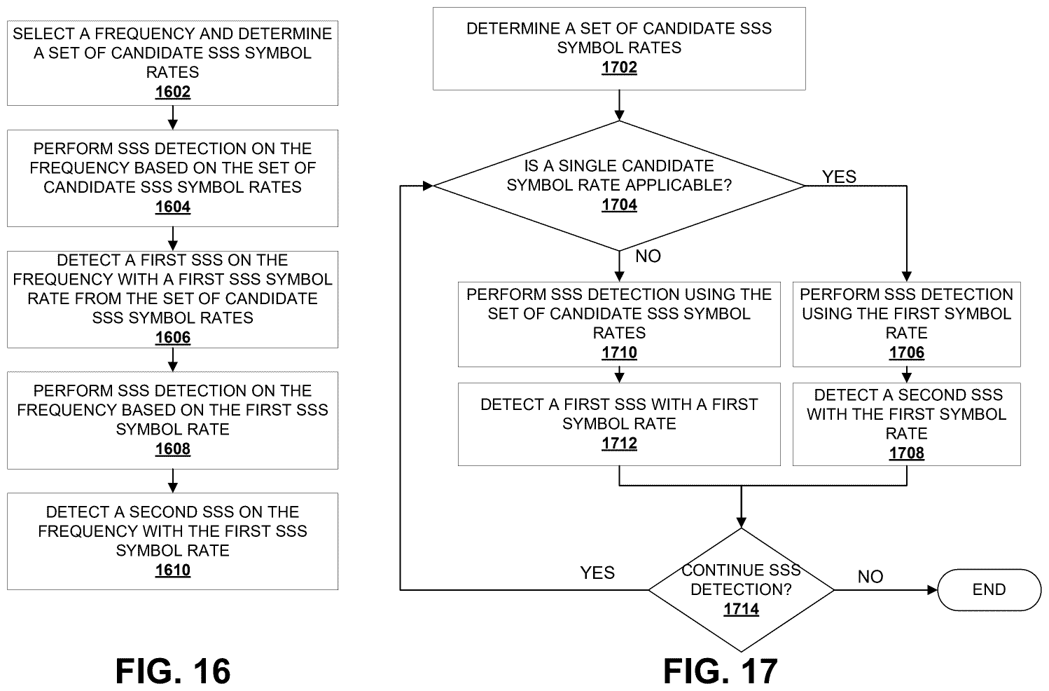

FIG. 16 is a procedural diagram illustrating an example of a procedure to use multiple candidate SSS symbol rates for SSS detection. As shown in FIG. 16, a WTRU 102 may select a frequency and determine a set of candidate SSS symbol rates at 1602. The WTRU 102 may perform SSS detection on the frequency based on the set of candidate SSS symbol rates at 1604. The WTRU 102 may detect a first SSS on the frequency with a first SSS symbol rate from the set of candidate SSS symbol rates at 1606. The WTRU 102 may perform SSS detection on the frequency based on the first SSS symbol rate at 1608. The WTRU 102 may detect a second SSS on the frequency with the first SSS symbol rate at 1610.

With respect to FIG. 16, it may be beneficial that the WTRU 102 needs to use the multiple candidate SSS symbol rates (e.g., only) for the first SSS detection. After the first SSS detection, and the determination of the SSS symbol rate of the first SSS, the WTRU 102 may use a single candidate SSS symbol rate for subsequent SSS detections on the frequency. In some representative embodiments, the WTRU 102 may use the SSS symbol rate of a first detected SSS on a first frequency also on other frequencies, such as other frequencies in the same band and/or within a certain frequency offset from the frequency of the first detected SSS.

While constraining the number of candidate SSS symbol rates on a frequency may be beneficial from the WTRU 102 point of view, it may put restrictions on the network side. One way to alleviate the network side restrictions is to introduce conditions on when a WTRU 102 may assume that the symbol rate of a previously detected SSS also applies to other SSSs (e.g., on the same frequency). For example, a WTRU 102 may assume that the SSS symbol rate of a first detected SSS (e.g., first symbol rate) is applicable during a certain time (e.g., a time period of T_{SSS} seconds, radio frames, etc.) after the reception of the first SSS. For example, the WTRU 102 may assume that the first symbol rate is applicable as long as the received power of the first detected SSS is above a threshold. These two conditions may be combined. For example, a WTRU 102 may assume that the first symbol rate is applicable during a certain time after the reception of the first SSS and/or as long as the received power of the first SSS is above a threshold. For example, a WTRU 102 may assume the first symbol rate may be applicable as long as the received power of the first SSS is above a threshold and also during a certain time after the first reception of the first SSS for which the received power is below a threshold (e.g., when for the previous SSS reception, the received power was above the threshold). In some representative embodiments, a WTRU 102 may no longer assume the first symbol rate is applicable when the received power of the first SSS is below a threshold for a certain number of consecutive SSS transmission and/or reception occasions, such as where the number of occasions may be specified and/or configured.

FIG. 17 is a procedural diagram illustrating an example of a procedure to use a single candidate symbol rate for SSS detection. As shown in FIG. 17, a may determine a set of candidate SSS symbol rates (e.g., for one or more frequencies) at 1702. The WTRU 102 may determine whether or not a single candidate symbol rate is applicable (e.g., as described herein) at 1704. If the WTRU 102 has determined that the single symbol rate is applicable, the WTRU 102 may perform SSS detection using the first symbol rate at 1706. The WTRU 102 may detect a second SSS with the first symbol rate at 1708. If the WTRU 102 has determined that the single symbol rate is not applicable, the WTRU 102 may perform SSS detection using the set of candidate SSS symbol rates at 1710. The WTRU 102 may detect a first SSS with a first symbol rate (e.g., from the set of candidate SSS symbol rates) at 1712. Thereafter, the WTRU 102 may determine whether to continue with SSS detection (e.g., on one or more frequencies) at 1714.

In FIG. 17, it should be noted that the “first detected SSS” or “first SSS” (used interchangeably) may not necessarily be the first SSS that the WTRU 102 detected on a frequency, but rather a label. The first SSS may, for example, be the latest detected SSS on the frequency, the latest detected SSS with received power above a threshold on the frequency, and/or the detected SSS with greatest received power on the frequency.

### Procedures for Determination of SSS Center Frequency

In certain representative embodiments, a WTRU 102 may perform PSS detection on a set of PSS synchronization frequencies (e.g., a synchronization raster). As the WTRU 102 effort grows with the size of the set, it may be beneficial to keep the size small. On the other hand, it may be beneficial to support a variety of carrier center frequencies, such as to support a large variety of channel allocations, TRP implementations, etc. Requiring that a SC-FDE PSS is transmitted with the same center frequency as the carrier center frequency would imply that a large set of PSS synchronization frequencies would be required. It is also noted that an SC-FDE SSS with a bandwidth close to the carrier bandwidth may need to be transmitted with the same center frequency as the carrier center frequency.

To address these issues, a SC-FDE PSS center frequency may be decoupled from a SC-FDE SSS center frequency. As long as the PSS fits within the channel, a sparse set of PSS synchronization frequencies may be combined with a larger set of SSS center frequencies. However, upon PSS detection, the WTRU 102 may need to determine the SSS center frequency.

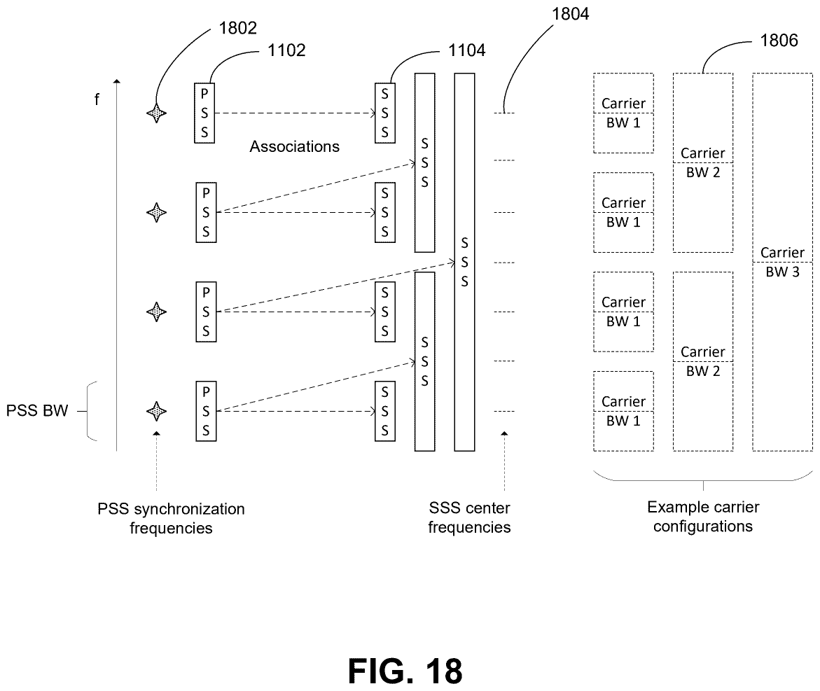

FIG. 18 is a bandwidth diagram illustrating examples of PSS synchronization (e.g., center) frequencies and SSS center frequencies As shown in FIG. 18, the PSS synchronization frequencies 1802 and the SSS center frequencies 1804 may be decoupled. As shown in FIG. 18, (e.g., a part of) a frequency band may include four PSS synchronization frequencies 1802 (e.g., as part of a synchronization raster). A PSS synchronization frequency 1802 may be associated with a set of candidate SSS center frequencies 1804, which may comprise one or more frequencies. In some embodiments, each PSS frequency may be associated with no more than two candidate SSS center frequencies 1804. For example, the number of PSS synchronization frequencies 1802 may be (e.g., almost) half of the number of candidate SSS frequencies and/or carrier frequencies 1806.

For example, the network may transmit an SC-FDE PSS using a PSS synchronization frequency that is different to a transmitted SSS center frequency, and the network may need to switch carrier frequency when transmitting the PSS(s). If the SSS(s) and PBCH(s) are transmitted using the same center frequency as the network uses for transmitting control, data, RSs, etc., additional frequency switching may be avoided.

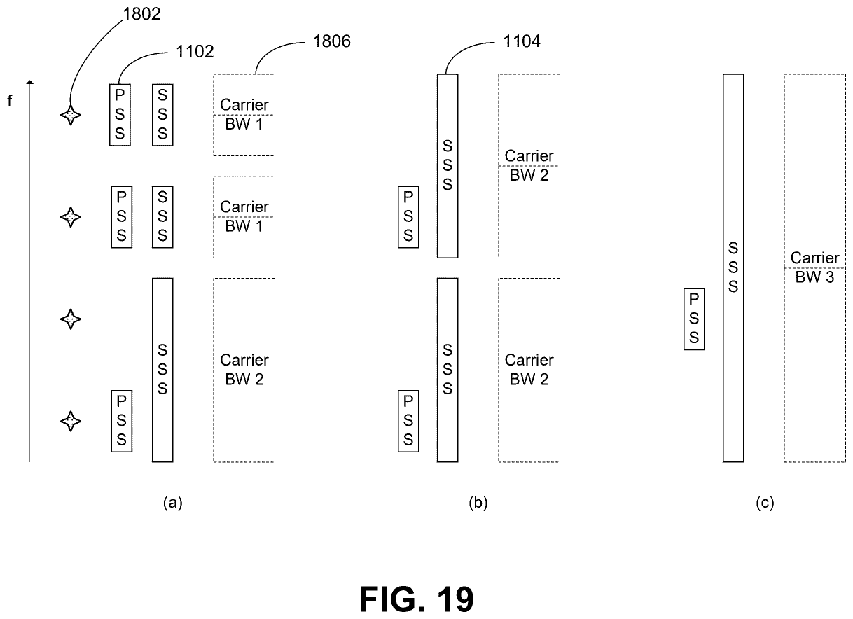

FIG. 19 is a bandwidth diagram illustrating examples of PSS and SSS frequencies and carrier configurations. In FIG. 19, three example configurations are shown which may be supported by the scheme illustrated in FIG. 18. In FIG. 19, a PSS 1102 may be transmitted in the bandwidth of each carrier 1806. In example (a) of FIG. 19, the network transmits three carriers 1806 within the shown bandwidth (BW), two carriers 1806 with a smaller BW (e.g., BW 1) and one carrier with a larger BW (e.g., BW 2). A WTRU 102 may detect a PSS 1102 on three of the four PSS synchronization frequencies (e.g., points). Upon detecting a PSS, the WTRU 102 may detect an SSS 1104 on one of the associated SSS center frequencies. In example (b) of FIG. 19, the network transmits two carriers 1806 within the shown bandwidth (BW) with two carriers 1806 with a same BW (e.g., BW 2). In example (c) of FIG. 19, the network transmits one carrier 1806 within the shown bandwidth (BW) (e.g., BW 3).

In FIG. 19, it should be noted that it may not be necessary to transmit/receive a PSS 1102 in each carrier. Rather, a WTRU 102 may receive a PSS 1102 in a first carrier, while not receiving a PSS in a second carrier, such as where the second carrier may be in the same or different frequency band as the first carrier.

In certain representative embodiments, a WTRU 102 may detect a PSS on a synchronization frequency. Upon detection of a PSS on a synchronization frequency, the WTRU 102 may determine a set of candidate SSS center frequencies. For example, different center frequencies in the set may be associated with various other SSS parameters, such as symbol rate, sequence, RRC roll off factor, or other parameter as described herein. For example, a candidate center frequency may be associated with a symbol rate, roll off factor, or other parameter as described herein. Based on the set of candidate SSS center frequencies, the WTRU 102 may perform SSS detection/measurement, and may decode a PBCH associated with a candidate SSS. Upon detection of an SSS with a center frequency from the set of candidate SSS center frequencies (e.g., an SSS with an RSRP above a threshold), the WTRU 102 may terminate SSS detection of SSS candidates with other center frequencies from the set. As another example, the WTRU 102 may perform SSS detection of SSS candidates with other center frequencies from the set (e.g., even if an SSS was already detected).

In certain representative embodiments, a WTRU 102 may select a subset of candidate SSS symbol rates based on the location of the SSS center frequency (e.g., within the frequency band). For example, a lower band edge and a higher band edge may be defined (e.g., in a specification and/or configured). The WTRU 102 may exclude candidate SSS symbol rates from a subset that corresponds to an SSS that does not fulfil radio requirements, such as where the SSS occupied bandwidth extends beyond an edge. Different SSS roll-off factors may be assumed for different SSS center frequencies, and potentially also for different candidate SSS symbol rates on a center frequency. For example, a stricter roll-off factor may be applicable closer to an edge, while a more relaxed roll-off factor may be assumed further from an edge.

### Procedures for Determination of SSS Time-Domain Location and Sequence

In certain representative embodiments, a location in time of an SSS in relation to a PSS may be pre-defined in a specification. For example, an SSS may immediately follow a PSS. In another example, an SSS may follow a pre-defined time after a PSS. In some representative embodiments, an SSS follows a PSS in time. In some representative embodiments, a PSS follows an SSS in time. In cases of periodic (e.g., always on) PSS and SSS, an SSS occasion may come after a PSS occasion and before another PSS occasion.

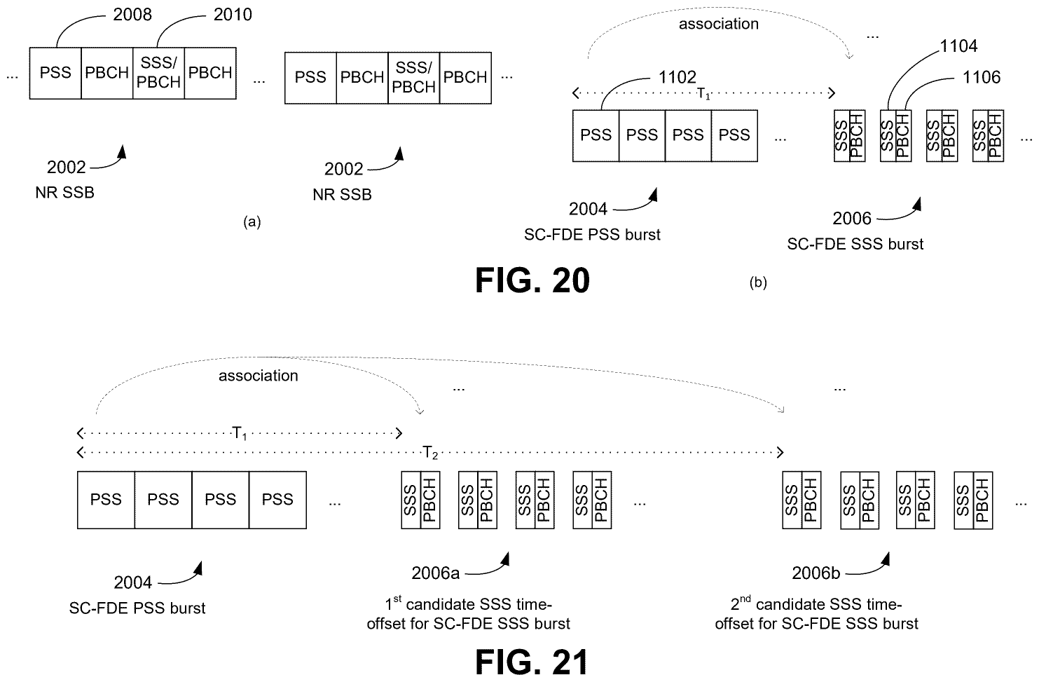

FIG. 20 is a diagram illustrating an example of a NR SSB 2002 and an example of a SC-FDE PSS burst 2004 and a SSS burst 2006. In 5G NR, a PSS 2008 and a SSS/PBCH 2010 are transmitted together in an NR SSB 2002, as illustrated in (a) of FIG. 20. For SC-FDE based synchronization signals, PSS 1102 and SSS 1104 may use different symbol rates, center frequencies, etc. Since switching between symbol rates, center frequencies, and the like, may involve various operations at the transmitter and/or receiver (e.g., a bandwidth or center frequency switching delay at the WTRU 102), it may be beneficial to separate the PSS 1102 and SSS 1104 in time. PSS and SSS separation in time is illustrated in (b) of FIG. 20. The one or more PSS(s) with a first symbol rate are transmitted together in time (e.g., back-to-back or not back-to-back), in what may be referred to as a PSS burst. In some cases, consecutive PSSs in a PSS burst 2004 are separated by a PSS CP, which may be a form of back-to-back transmission. In some representative embodiments, a PSS burst 2004 is divided into multiple PSS sub-bursts, wherein the PSSs in a sub-burst may be transmitted back-to-back while the last PSS in a sub-burst and the first PSS in a subsequent PSS sub-burst may not be transmitted back-to-back. For example, symbol rate switching between the PSS(s) in a PSS burst may not be needed.

At a later point in time (e.g., after T₁) from the PSS burst, a WTRU 102 may receive an SSS (e.g., an SSS that is associated with a detected PSS). The SSS(s) 1104 corresponding to the PSS(s) 1102 in a PSS burst 2004 may be called an SSS burst 2006. Another benefit of a PSS burst 2004 that is separate in time is that a WTRU 102 that only is attempting PSS-based detection/measurement may find all PSS(s) (e.g., of a cell) in a shorter time window than if other signals and/or channels, such as SSS/PBCH, were time multiplexed with the PSS(s). Similarly, a WTRU 102 that is only receiving SSS (e.g., for SSS-based measurements) may receive all SSS(s) in a shorter time window. As shown in (b) of FIG. 20, a PBCH block 1106 may follow an SSS 1104. Note that further details of the time domain location of a PBCH are discussed elsewhere herein.

In FIG. 20, an association between a PSS 1102 and an SSS 1104 is illustrated with a dashed arrow. The association may include a QCL relationship between the PSSs 1102 and the associated SSSs 1104, wherein the QCL relationship may comprise time and/or frequency synchronization (e.g., Doppler shift, Doppler spread, average delay, delay spread, etc.), average gain, and/or spatial parameter (e.g., WTRU 102 Rx beam), or the like. For example, the association may be defined, at least partly, using the time offset between the PSS and the associated SSS (e.g., T₁). In some representative embodiments, the association comprises both time/frequency synchronization and one or more spatial parameters. In some representative embodiments, the association may comprise (e.g., only) time/frequency synchronization. In some representative embodiments s, the association may comprise (e.g., only) time synchronization, such as where the WTRU 102 may determine one or more SSS time location hypotheses from a detected PSS. For example, a SSS time domain location may comprise a PSS time domain location (e.g., of a PSS associated with the SSS) and a time offset.

### Multiple Candidate Time Offsets

In certain representative embodiments, a candidate PSS-to-SSS time offset may be used.

For example, there may be a single candidate SSS time domain location, given a detected PSS, as illustrated in (b) of FIG. 20, at least to the level of time synchronization offered by the PSS. As another example, different candidate SSS symbol rates may be associated with different SSS time domain locations (in relation to the PSS), with a one-to-multiple association.

FIG. 21 is a diagram illustrating an example of multiple candidate time offsets for an associated SSS. In FIG. 21, there are two candidate time offsets (e.g., T1 and T2) between the PSS burst 2004 and the SSS bursts 2006a, 2006b. A candidate time offset may be associated with a set of candidate SSS symbol rates, such as where a set of candidate SSS symbol rates may comprise one or more candidate symbol rates. For instance, each candidate SSS symbol rate may correspond to a different candidate time offset. Such a scheme could enable sequential reception using different receiver sampling rates (e.g., corresponding to different SSS symbol rates). Furthermore, different candidate SSS center frequencies may (e.g., also) be associated with different SSS time domain locations. For example, a first candidate time offset may be associated with a first set of one or more candidate SSS center frequencies and a first set of one or more candidate SSS symbol rates, and a second candidate time offset may be associated with a second set of one or more candidate SSS center frequencies and a second set of one or more candidate SSS symbol rates.

In FIG. 21, the one or more candidate time offsets (e.g., T1 and T2) may be given by a specification and/or configured. For example, the one or more candidate time offsets may depend on one or more of the following factors: the PSS symbol rate, the synchronization frequency, the frequency band, the PSS sequence, the PSS CP duration, and/or SSS center frequency, and the like. Upon PSS detection, a WTRU 102 may determine a set of candidate SSS time offsets (e.g., and corresponding SSS symbol rates, center frequencies, etc.) based on one or a combination of these factors.

In certain representative embodiments, there may be QCL assumptions for different PSS-to-SSS time offsets.

In certain representative embodiments, there may be multiple candidate SSSs that are associated with a PSS, and a QCL relationship may apply to all or a subset of the candidate SSSs. For example, different QCL relationships may apply between the PSS and different sets of associated candidate SSSs. For example, in the case of multiple candidate SSS time-offsets associated with a PSS, both time and frequency QCL (e.g., QCL typeA or typeC) and spatial QCL (e.g., QCL typeD) may apply to a first set of candidate SSS time-offsets (e.g., for a particular SSS symbol rate, center frequency, etc.) or a first candidate SSS time-offset. For example, only time and frequency QCL (e.g., or only spatial QCL) may apply to a second set of candidate SSS time-offsets (e.g., for a particular SSS symbol rate, center frequency, etc.). For example, a first QCL relationship (e.g., time, frequency, spatial) may apply to a first SSS burst, while a second QCL relationship (e.g., time, frequency) may apply to a second SSS burst, where the first and second SSS bursts may correspond to the same or different SSS symbol rates, center frequencies, etc. The approach with different QCL relationships for different SSS candidates gives the network some flexibility, such as for transmitting an associated SSS in a manner that is spatially QCL'd with the PSS (e.g., from the same TRP as the PSS), or in a manner that is not spatially QCL'd with the PSS (e.g., from a set of TRPs that is different from the set of TRPs used to transmit the PSS).

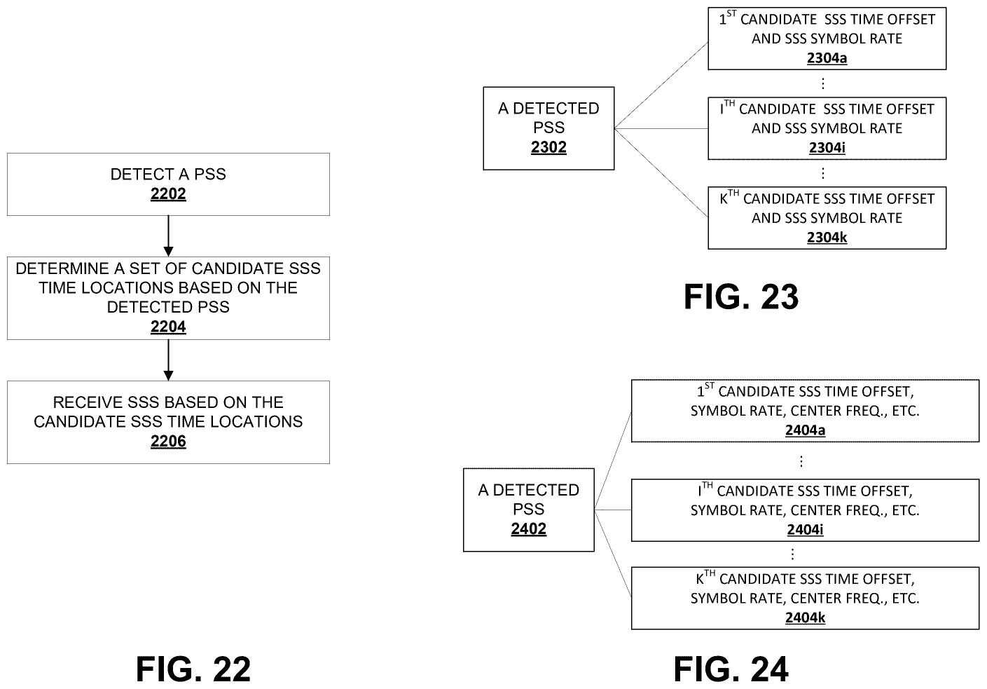

FIG. 22 is a procedural diagram illustrating an example of a procedure to determine a SSS time-domain location. In FIG. 22, a WTRU 102 may detect a PSS at 2202. The WTRU 102 may determine a set of candidate SSS time locations (e.g., based on the detected PSS) at 2204. The WTRU 102 may receive an SSS based on the candidate SSS time locations at 2206. The determination of the set of candidate SSS time domain locations may be based on the detected PSS may further use the PSS timing and one or more time offsets to determine the candidate SSS time locations. The determination may (e.g., also) use other parameters of the detected PSS (e.g., the PSS sequence, PSS symbol rate, and the like) to determine the candidate SSS time domain locations. For example, different PSS symbol rates may be associated with different candidate SSS time offsets. One way to describe a time offset is as an integer number of symbols, such as where the symbol duration corresponds to the PSS symbol duration (e.g., which is a function of the PSS symbol rate). Another way to describe a time offset is as an integer number of SC-FDE blocks, such as where the SC-FDE block may comprise a number of symbols (e.g., equal to the PSS duration, or to another integer number) plus a number of CP symbols, if any, with a symbol duration corresponding to the PSS symbol duration.

In certain representative embodiments, there may be multiple candidate SSS time offsets for a detected PSS.

In some representative embodiments, it may be beneficial for the network to transmit a lower number of PSS than the number of SSS (e.g., in a cell, a carrier, etc.). For example, the one or more PSS may be transmitted on wider beams than the SSS. For example, a single PSS may be transmitted while multiple SSS are transmitted. This may be the case, for example, if the PSS is transmitted using a wide beam and/or multi-TRP joint transmission (e.g., SFN-like transmission).

In some representative embodiments, there may be fewer PSSs than SSSs, and a PSS may be associated with multiple candidate SSS time offsets, such as for a subset (or all) of the multiple candidate SSS time offsets that correspond to the same candidate SSS symbol rate and/or center frequency. For instance, N_{SSS,m} candidate SSS time offsets may be associated with the m^{th} candidate SSS symbol rate.

FIG. 23 is a diagram illustrating an example of multiple candidates for SSS time offset and SSS symbol rate. In FIG. 23, a WTRU 102 may, for a detected PSS 2302 (e.g., upon PSS detection), use multiple candidate SSS time offsets and symbol rates. As shown in FIG. 23, the WTRU 102 may use K candidate parameter sets 2304a to 2304i to 2304k. For example, a K^{th} candidate 2304k may include a time offset and/or a symbol rate. A subset (e.g., one or more) of the K candidates may include a same SSS time offset. This may mean that a WTRU 102 may use multiple candidate SSS symbol rates for the same candidate time offset. Similarly, a subset (e.g., one or more) of the K candidates may comprise the same candidate SSS symbol rate. This may mean that a WTRU 102 may use multiple candidate SSS time offsets for a same candidate symbol rate (e.g. N_{SSS,m} candidate SSS time offsets for the m^{th} candidate symbol rate). For example, a set of (e.g., K pairs of) candidate SSS time offsets and symbol rates may depend on various PSS parameters as described herein (e.g., PSS symbol rate, sequence, synchronization frequency, CP duration, etc.).

FIG. 24 is a diagram illustrating another example of multiple candidates for SSS time offset, symbol rate, and center frequency. In FIG. 24, a WTRU 102 may, for a detected PSS 2402 (e.g., upon PSS detection), use multiple candidate parameter sets. As shown in FIG. 24, the WTRU 102 may use K candidate sets 2404a to 2404i to 2404k. Note that, in some embodiments, one or more further candidate SSS parameters may be considered, such as SSS center frequency as in FIG. 24 and/or SSS sequence. Additional details regarding sequence candidates (e.g., hypotheses) are discussed elsewhere herein.

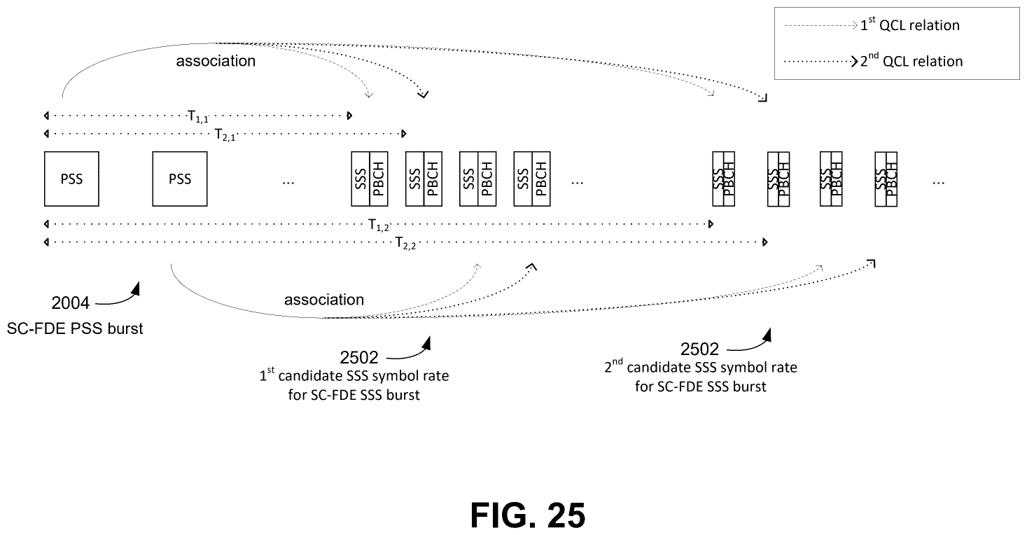

FIG. 25 is a diagram illustrating an example of a set of candidate SSS time offsets and symbol rates. As shown in FIG. 25, a WTRU 102 may use multiple candidate time offsets T_{1,1} and T_{2,1} for (e.g., in association with) a first candidate SSS symbol rate 2502, and multiple candidate time offsets T_{1,2} and T_{2,2} for (e.g., in association with) a second candidate SSS symbol rate 2502. For example, this may correspond to a scenario in which SSS(s) are transmitted in more narrow beams than the associated PSS. In some representative embodiments, a PSS may be jointly transmitted from a set of multiple TRPs, while one or more associated SSS(s) may be transmitted from single TRPs from the set of multiple TRPs. It should be noted that it may be up to the network implementation if a candidate SSS is transmitted or not.

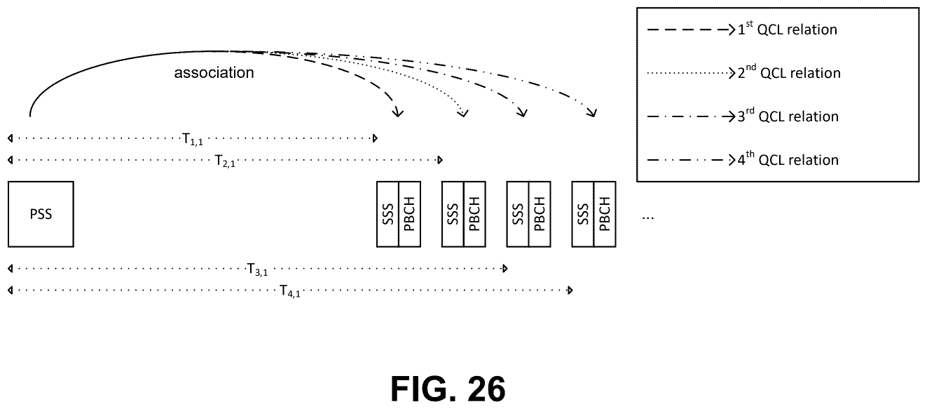

FIG. 26 is a diagram illustrating an example of a single PSS corresponding to multiple candidate SSS time-offsets. In certain representative embodiments, a PSS may be associated with multiple candidate SSSs and multiple QCL relations. As shown in FIG. 26, a single PSS may be associated with four candidate SSS(s) with a first SSS symbol rate, where the different time offsets T_{1,1}, T_{2,1}, T_{3,1} and T_{4,1} may correspond to (e.g., be associated with) four different QCL relations. In FIG. 26, the QCL relation between the PSS and the first SSS is of a first type (e.g., including delay, frequency shift, and spatial QCL parameter(s)), whereas the QCL relation between the PSS and the second, third, and fourth SSS may be of a second type (e.g., including delay and frequency shift, but not spatial QCL parameter(s)).

It should be noted that the network may reconfigure the QCL relations between the PSS and the SSSs (e.g., in or via non-standalone access and/or system information). For instance, in initial access, a WTRU 102 may assume a QCL relation between a PSS and an SSS of a second type (e.g., excluding spatial parameters and/or QCL), but later receive assistance information from the network that the QCL relation is of a first type (e.g., including spatial parameters and/or QCL).

The introduction of multiple candidate SSS time-offsets may increase the total amount of candidate SSSs. To alleviate at least some of the increased WTRU 102 SSS detection effort, the amount of candidate SSSs in other dimensions may be reduced. For example, the number of different SSS sequences may be reduced. Furthermore, as also discussed herein, candidate SSS parameter values in different dimensions may be linked, which may (e.g., dramatically) reduce the number of combinations and/or candidates. For example, a first candidate time offset may be linked with a first candidate symbol rate and/or a first center frequency, while a second candidate time offset may be linked with a second candidate symbol rate and/or a candidate center frequency. Even though there are two candidate time offsets, two candidate symbol rates, and two candidate center frequencies, there may only be two candidate SSSs, not 2*2*2 (i.e., 6) candidates. In other words, the WTRU 102 may determine multiple sets of (e.g., linked) candidate SSS parameter values, such as a first set with a first time offset value, a first center frequency value, a first symbol rate value, a second set with a second time offset value, a second center frequency value, a second symbol rate value, and so forth.

### SSS1 and SSS2

In certain representative embodiments, to keep the number of candidate SSSs down while still supporting a high number of IDs (e.g., PCIs) that can be derived from the set of synchronization signals is to consider the PSS as a first SSS (e.g., first SSS block) and a second SSS (e.g., second SSS block). For convenience, the first SSS may be denoted “SSS1” while the second SSS may be denoted “SSS2”. For example, a SSS2 is not a second SSS, but rather a distinct SS, as the primary and secondary SSs are. For example, a SSS1 and a SSS2 may be coupled, such as where a WTRU 102 may assume that they are transmitted on the same antenna port (e.g., on the same beam).

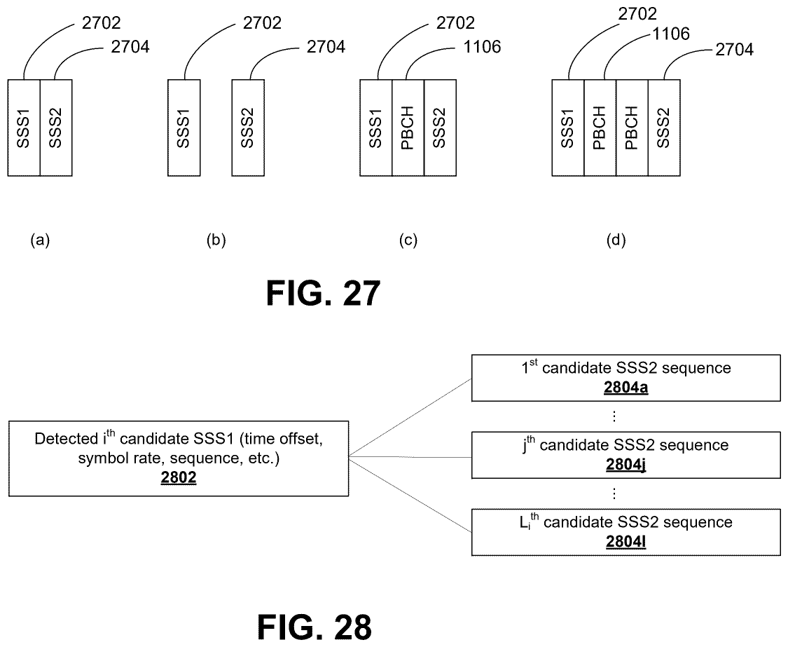

FIG. 27 is a diagram illustrating examples of SSS1, PBCH and SSS2. In example (a) of FIG. 27, an SSS1 block 2702 and a corresponding SSS2 block 2702 are adjacent in time. In example (b) of FIG. 27, an SSS1 block 2702 and a corresponding SSS2 block 2704 are not adjacent in time (e.g., separated by an SC-FDE block). In example (c) in FIG. 27, a PBCH block 1106 may be received between an SSS1 block 2702 and a corresponding SSS2 block 2704 (e.g., on the same antenna port as the SSS1 and SSS2). In example (d) of FIG. 27, multiple (e.g., two) PBCH blocks 1106 may be received between an SSS1 2702 and a corresponding SSS2 2704 (e.g., on the same antenna port as the SSS1 and SSS2).

One way to describe a time offset is as an integer number of symbols, such as where the symbol duration may correspond to the SSS1 symbol duration (e.g., which is a function of the SSS1 symbol rate). Another way to describe a time offset is as an integer number of SC-FDE blocks, where the SC-FDE block may comprise a number of symbols (e.g., equal to the SSS1 duration, or to another integer number) plus a number of CP symbols, if any, with a symbol duration, for example, corresponding to the SSS1 symbol duration.

In some representative embodiments, a WTRU 102 may assume that the SSS2 uses the same symbol rate as the SSS1. In some other representative embodiments, the SSS2 symbol rate may be given by the SSS1 symbol rate. In some representative embodiments, the SSS2 may be one or more repetition(s) of the SSS1 using the same or a different sequence. In some representative embodiments, the sequence space of the SSS1 may be a subset of the sequence space of the SSS2. In some representative embodiments, the total sequence space of SSS1 and SSS2 may be defined, such as through one or more sets of cyclic shifts of one or more sequences that are used to construct both the SSS1 and SSS2 sequences. For example, the set of SSS1 sequences (e.g., the SSS1 sequence space) may comprise a subset of the total sequence space. For example, the set of SSS2 sequences (e.g., the SSS2 sequence space) may comprise a subset of the total sequence space. For example, the set of SSS1 sequences and SSS2 sequences may be disjoint. For example, the union of the set of SSS1 sequences and the set of SSS2 sequences may comprise the total sequence space. For example, the set of SSS1 sequences may be a subset of the set of SSS2 sequences.

In certain representative embodiments, such as where a WTRU 102 uses multiple candidate SSS1 time offsets, center frequencies, and/or SSS1 symbol rate, the total amount of candidates may be reduced by limiting the number of candidate SSS1 sequences. After the WTRU 102 has detected SSS1, the WTRU 102 may have determined the SSS1 time offset, center frequency, and/or symbol rate. For example, the SSS2 time offset, center frequency, and SSS2 symbol rate may (e.g., also) be known. For SSS2 detection, the WTRU 102 may detect a SSS2 sequence from a set of SSS2 sequences, wherein the set of SSS2 sequences may be larger than the set of SSS1 sequences. It should be noted that by splitting the time offset, center frequency, symbol rate, and/or sequence candidates into SSS1 and SSS2, the total number of candidates may be (e.g., drastically) reduced.

In a numerical example, consider 64 time-offset candidates, 8 symbol rate candidates, and 336 sequence candidates. If all of these candidates would be associated with SSS1, the total number of candidates would be 64*8*336=172,032 candidates. If, instead, the SSS1 is associated only with the time-offset and symbol rate candidates, while the SSS2 is associated only with the sequence candidates, the total number of candidates (SSS1+SSS2) would be 64*8+336=848 candidates. For interference suppression purposes, such as for SSS1 based channel estimation, it may be beneficial to at least partly encode a PCI or other ID (e.g., TRP ID, beam ID, etc.) into an SSS1 sequence. For example, consider a modification in which SSS1 is associated with 8 sequences, which means that SSS2 may be associated with only 84 sequences (8*84=336). In this case, the total number of candidates (SSS1+SSS2) would be 64*8*8+84=4180 candidates, which may still be feasible, especially considering that the blind candidate detection (e.g., hypothesis testing) may be performed only during initial access, in which no prior information is given.

FIG. 28 is a diagram illustrating an example of multiple candidate SSS2 sequences which are associated with SSS1 detection. In FIG. 28, upon detection of the i^{th} SSS1 candidate 2802, a set of candidate SSS2 sequences 2804a to 2804j to 2804l may be determined. If the SSS1 corresponds to a set of candidate time offsets and symbol rates, then the WTRU 102 may determine the time offset and symbol rate of the corresponding SSS2 from the corresponding SSS1 time offset and symbol rate. For example, only Lᵢ candidate SSS2 sequence hypotheses may remain for the WTRU 102 to detect.

In certain representative embodiments, a set of candidate SSS2 sequences may depend on the detected SSS1 candidate. For example, a WTRU 102 may determine the set of Lᵢ candidate SSS2 sequences based on the time offset, symbol rate, and/or sequence of the coupled (e.g., associated) SSS1, such as the i^{th} SSS1 candidate.

In certain representative embodiments, the information conveyed to the WTRU 102 by the SSS1 sequence may be separate from the information conveyed by the SSS2 sequence. In certain representative embodiments, one or more pieces of information may be carried jointly in an SSS1 and a SSS2 (e.g., a first part of a PCI may be carried in an SSS1 and second part of a PCI may be carried in a SSS2).

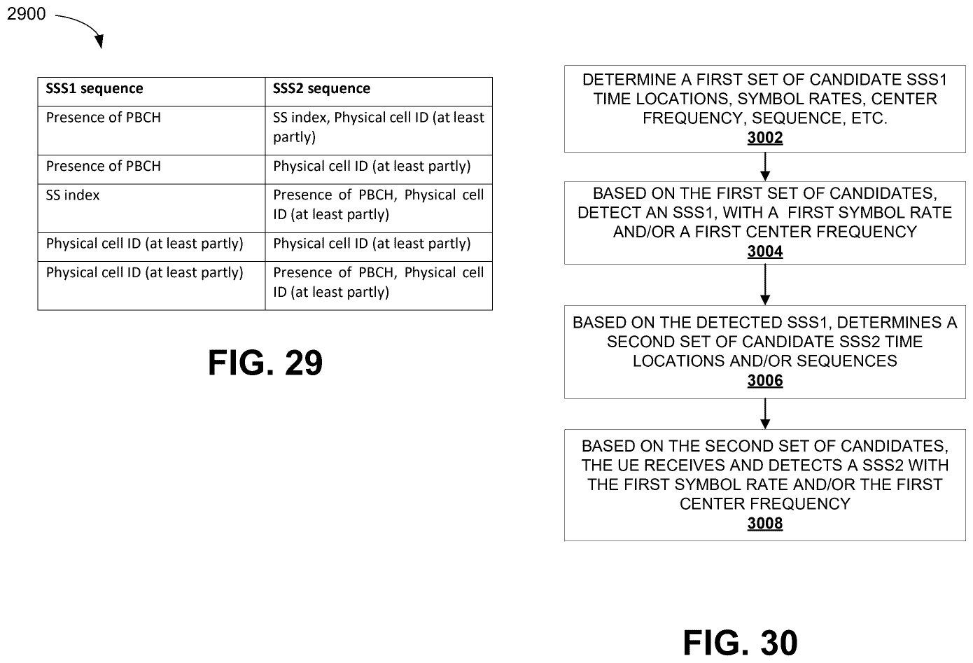

FIG. 29 is a table diagram illustrating an example of information carried by SSS1 and SSS2 sequences. In the table 2900 in FIG. 29, various exemplary combinations are shown. For example, an SS index may correspond to a time offset and may also represent a beam index, (e.g., similar to SSB index in NR). For example, a physical cell ID may be encoded at least partly in any of a PSS, SSS1 and/or a SSS2. For example\grave{ }, a TRP ID or beam ID may be used instead of a PCI, or in addition to a PCI. For example, in FIG. 29, the physical cell ID is used as an example ID herein, but other kind(s) of ID(s) may be carried by the synchronization signal(s) in other embodiments.

In certain representative embodiments, a WTRU 102 may determine multiple candidate SSS2 time domain locations based on a detected and coupled SSS1. For example, two different candidate SSS2 time domain locations may be used, such as to indicate the presence of PBCH.

FIG. 30 is a procedural diagram illustrating an example procedure using multiple SSS2 hypotheses. In FIG. 30, a WTRU 102 may determine a first set of candidate SSS1 time location(s), symbol rate(s), center frequency(s), and/or sequence(s) and the like at 3002. The WTRU 102 may detect an SSS1, such as with a first symbol rate, and/or first center frequency based on the determined first set of candidates at 3004. The WTRU 102 may determine a second set of candidate SSS2 time location(s) and/or sequence(s) based on the detected SSS1 (e.g., and corresponding SSS1 parameter values) at 3006. For example, the determination of candidate SSS2 time locations may be based on the time location of the detected SSS1, such as a set of candidate SSS2 time offset(s) in relation to the detected SSS1. The WTRU 102 may receive and detect an SSS2 with the first symbol rate and/or the first center frequency which may be based on the determined second set of candidates at 3008.

### SSS1 and SSS2 Sequence Generation

In certain representative embodiments, the SSS1 and SSS2 sequences may be generated as a set of SSS sequences. For example, The set of all SSS sequences {_{d}_{_{SSS}}₍ₙ₎} comprising of the union of SSS1 and SSS2 sequences may for example be defined by

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

$$where$$

$$\begin{matrix}{x}_{0} ( i + 7 ) = ( {x}_{0} ( i + 4 ) + {x}_{0} ( i ) ) mod 2 \\ {x}_{1} ( i + 7 ) = ( {x}_{1} ( i + 1 ) + {x}_{1} ( i ) ) mod 2\end{matrix} ,$$

$$and$$

$$[ {x}_{0} ( 6 ) {x}_{0} ( 5 ) {x}_{0} ( 4 ) {x}_{0} ( 3 ) {x}_{0} ( 2 ) {x}_{0} ( 1 ) {x}_{0} ( 0 ) ] = [ 0000001 ]$$

$$[ {x}_{1} ( 6 ) {x}_{1} ( 5 ) {x}_{1} ( 4 ) {x}_{1} ( 3 ) {x}_{1} ( 2 ) {x}_{1} ( 1 ) {x}_{1} ( 0 ) ] = [ 0000001 ]$$

### PSS and SSS Periodicity

In certain representative embodiments, a PSS and an associated SSS may be transmitted/received with different periodicity. For example, a SSS periodicity may be longer or shorter than a PSS periodicity. For example, the longer periodicity may be an integer multiple of the shorter periodicity. In some representative embodiments, where the PSS periodicity is longer than the SSS periodicity, the WTRU 102 may find (e.g., expect to detect) an SSS at an expected time offset from the PSS.

In some representative embodiments, where the SSS periodicity is longer than the PSS periodicity, the WTRU 102 might not find an SSS at an expected time offset from each PSS, but only from some PSSs. For example, if the SSS periodicity is K times the PSS periodicity, where K is a positive integer, an SSS may be transmitted/received after every K^{th} (e.g., associated) PSS. If K, or a candidate set of K values, is known to the WTRU 102 (e.g., based on a specification and/or configuration), the WTRU 102 may perform SSS detection after K (or the maximum candidate K value) consecutive PSSs occasions. A benefit of longer SSS periodicity may be reduced network overhead and power consumption.

### Procedures for Determination of PBCH Resources

In certain representative embodiments, a SSS and PBCH may be used for different purposes, which may require different SSS and PBCH periodicities. For example, a SSS may be used for mobility measurements, while a PBCH may carry some system information. One approach to different SSS and PBCH periodicity requirements is to transmit both SSS and PBCH with the same periodicity as in 5G NR (e.g., the smallest required periodicity among the two). However, this may result in unnecessary resource overhead, especially if the required SSS periodicity is much smaller than the required PBCH periodicity. Hence, it may be beneficial to support different SSS and PBCH periodicities and WTRU 102 procedures to determine PBCH resources.

In certain representative embodiments, a WTRU 102 may determine a time and/or frequency resource for PBCH reception (e.g., based on the detected SSS). A PBCH may be transmitted together with an SSS (e.g., immediately before or after). A WTRU 102 may assume that a PBCH may be transmitted on the same antenna port as the SSS together with which it is transmitted. For example, with a periodic SSS, a PBCH may be present in some SSS occasions while being absent in other SSS occasions. For example, a WTRU 102 may perform blind PBCH detection/decoding to determine in which SSS occasion(s) a PBCH is present. As another example, a WTRU 102 may determine a PBCH resource based on the detected SSS (e.g., based on the SSS sequence). For example, a first SSS sequence may be used in SSS occasions with a present PBCH, while a second SSS sequence may be used in SSS occasions without a PBCH. For example, the first and second SSS sequences may comprise an SSS sequence pair that both may be associated with the same cell (e.g., same physical cell ID). For instance, a physical cell ID may be determined by the first SSS sequence but not by the second SSS sequence, or vice versa.

In certain representative embodiments, a WTRU 102 may determine a PBCH resource based on SSS1 and SSS2.

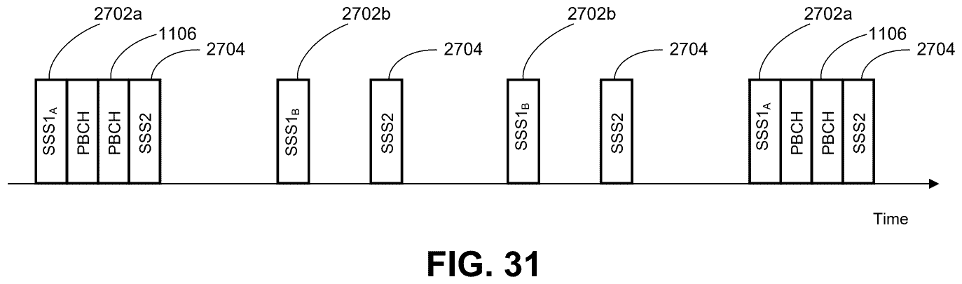

FIG. 31 is a timing diagram illustrating an example procedure using a SSS1 sequence to determine PBCH resources. For example, after determining a SSS1 symbol rate, time domain location and sequence, a WTRU 102 may proceed to determine the time domain location of a PBCH. For example, the determination of PBCH resources may depend on which SSS1 sequence is decoded. SSS1 sequences may be divided into two subsets, “A” and “B” as shown in FIG. 31. Subset “A” may be the subset of (e.g., all) SSS1 sequences, such as SSS1_{A} 2702a in FIG. 31, that are directly followed by one or more PBCH blocks 1106. Subset “B” may be the subset of (e.g., all) SSS1 sequences, such as SSS1_{B} 2702b in FIG. 31, that are not directly followed by a PBCH 1106. At each SSS1 transmission occasion, the base station may transmit one SSS1 sequence from the pairs (a, b), where “a”∈“A and “b”E “B”. Depending on which SSS1 sequence is decoded at a particular occasion, the WTRU 102 may be able to determine the time domain location of the PBCH 1106. In some examples, the PBCH may be separated by a time domain offset from an SSS1 sequence in subset “A”. This offset may be pre-defined in a specification and/or received by the WTRU 102 in a configuration.

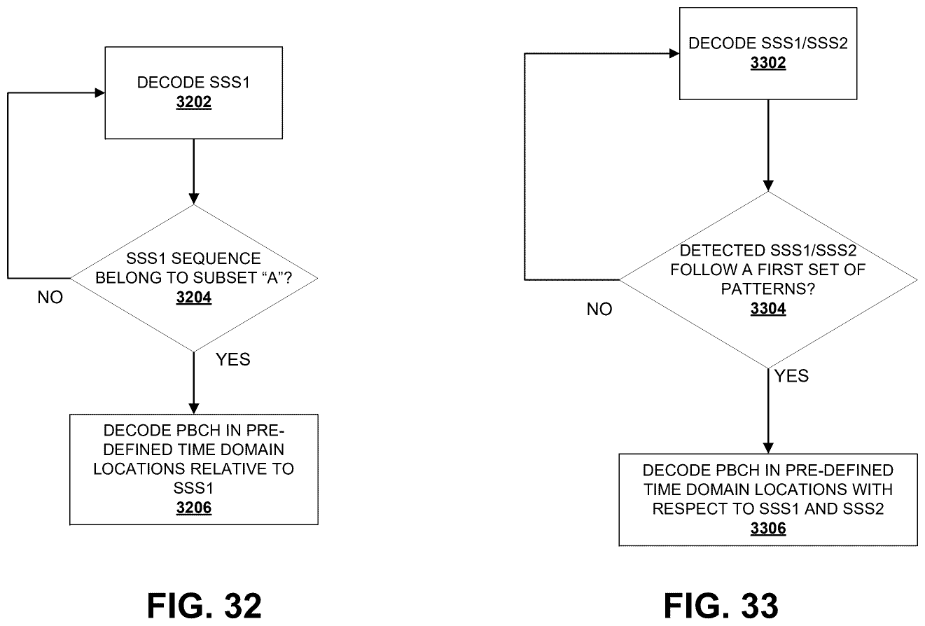

FIG. 32 is a procedural diagram illustrating an example procedure using a SSS1 sequence to determine PBCH resources. In FIG. 32, a WTRU 102 may decode a SSS1 (e.g., using a determined SSS1 symbol rate) at 3202. The WTRU 102 may determine whether or not the decoded SSS1 sequence belongs to the Subset “A” or not at 3204. If not, the WTRU 102 may proceed to decoding another SSS1. If the SSS1 sequence belongs to the Subset “A”, the WTRU 102 may proceed to decode a PBCH at 3206. For example, the PBCH may be located in one or more pre-defined time locations relative to the SSS1.

In certain representative embodiments, a WTRU 102 may be able to determine PBCH resources based on a first set of SSS time domain patterns.

FIG. 33 is a procedural diagram illustrating an example procedure to determine PBCH resources based on a SSS1/SSS2 set of time domain patterns. In FIG. 33, a WTRU 102 may decode a SSS1 and/or SSS2 at 3302. After decoding SSS sequence, the WTRU 102 proceeds to check if an SSS pattern is followed by the detected SSS1 and/or SSS2 at 3304. If so, the WTRU 102 may decode a PBCH based on a pre-defined PBCCH location relative to SSS at 3306. Otherwise, the WTRU 102 may proceed to decode the next SSS sequence. For example, time domain separation between SSS1 and SSS2 signals may be defined as D_{SSS}={1,2, . . . }. One way to describe D_{SSS} is as an integer number of symbols, where the symbol duration corresponds to the SSS1 symbol duration, which is a function of the SSS1 symbol rate. Another way to describe a time offset is as an integer number of SC-FDE blocks, where the SC-FDE block may comprise a number of symbols (e.g., equal to the SSS1 duration, or to another integer number) plus a number of CP symbols, if any, with a symbol duration corresponding to the SSS1 symbol duration. If D_{SSS} is equal to a pre-defined value, the WTRU 102 may assume D_{SSS} PBCH block(s) were transmitted. If D_{SSS} is equal to some other value, the WTRU 102 may assume that the PBCH is absent in the D_{SSS} blocks and/or other data or broadcast information are transmitted (e.g., “CORESET0”, paging, SI, etc.).

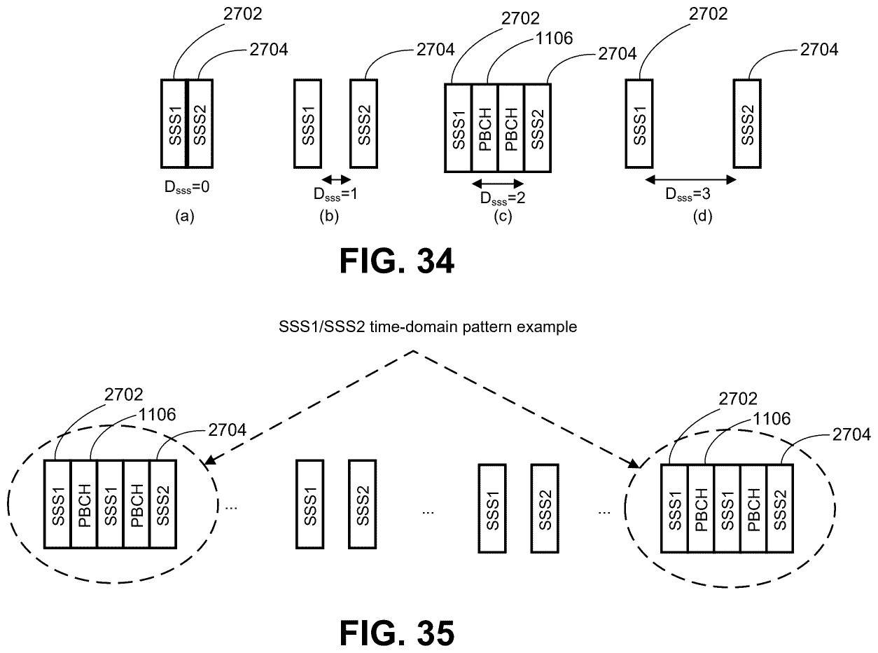

FIG. 34 is a diagram illustrating an example procedure using a SSS1 sequence to determine PBCH resources. In example (a) of FIG. 34, D_{SSS}=0 and no PBCH is transmitted in a SSS occasion. In example (b) of FIG. 34, D_{SSS}=1 and no PBCH 1106 is transmitted in a SSS occasion. In example (c) of FIG. 34, D_{SSS}=2 and PBCH is transmitted as two PBCH blocks 1106 in a SSS occasion. In example (d) of FIG. 34, D_{SSS}=3 and no PBCH is transmitted in a SSS occasion. In example (c), the SSS occasion is illustrated with two, as an example, PBCH blocks which are (e.g., directly) preceded by SSS1 2702 and followed by SSS2 2704.

FIG. 35 is a diagram illustrating examples of time-domain patterns based on time separation D_{SSS} between SSS1 2702 and SSS2 2704 for determination of a PBCH 1106 location. In FIG. 35, PBCH resources may be determined based on a pre-defined SSS1/SSS2 time-domain pattern (e.g., SSS1-PBCH-SSS1-PBCH-SSS2). In other embodiments, different SSS1/SSS2/PBCH time-domain patterns may be used for a SSS occasion.

In certain representative embodiments, the presence of SSS2 may indicate the presence of a PBCH in a SSS occasion. For instance, a first set of SSS1/SSS2 patterns may comprise a pattern without an SSS2. The WTRU 102 may detect an SSS2 in an SSS occasion. The WTRU 102 may then receive and decode a PBCH in the SSS occasion. On the other hand, if the WTRU 102 doesn't detect an SSS2 in an SSS occasion, the WTRU 102 may skip PBCH reception and/or decoding in the SSS occasion.

In certain representative embodiments, the presence of PBCH in a SSS burst may be based on PSS. For example, a PSS periodicity may be K time a SSS periodicity, where K is a positive integer, as discussed herein. This may indicate that some SSS occasions are preceded by an associated PSS (e.g., by a certain time offset) while other SSS occasions are not preceded by an associated PSS, but rather by another SSS occasion. In the case of longer PBCH periodicity than SSS periodicity, the PBCH presence in an SSS occasion may be based on whether the SSS occasion is preceded by an associated PSS. More generally, the PBCH presence in an SSS occasion may be based on whether the SSS occasion is the L^{th} SSS occasion after the SSS occasion that is preceded by an associated PSS, where L may be a non-negative integer.

In certain representative embodiments, the PBCH periodicity may be different from the PSS periodicity (e.g., an integer multiple M times the PSS periodicity). A WTRU 102 may perform PBCH detection in M consecutive candidate PBCH occasions, where candidate PBCH occasions may correspond to every K^{th} SSS occasion, such as every K^{th} SSS occasion which is the L^{th} SSS occasion after an SSS occasion that is preceded by an associated PSS.

Upon determination of resource(s) for PBCH, the WTRU 102 may receive PBCH on the determined resource(s), and decode the PBCH.

### Procedures for Determination of SS Index and Frame Timing

In certain representative embodiments, a SSS/PBCH block index may be provided to the WTRU 102 (e.g., explicitly) in the PBCH payload. The WTRU 102 may decode the PBCH to obtain a MIB which carries “x” bits for the SSB index. For example, the WTRU 102 may determine up to 2^{x} SSB indexes. In certain representative embodiments, a SSS/PBCH block index may be provided to the WTRU 102 implicitly. For example, the SSS/PBCH block index\grave{ } may depend on which SSS1 sequence is decoded (e.g., SSS1 sequence pairs are indexed, such as 1, 2, 3, etc.). A SSS1 sequence pair of index “1” may correspond to an SSS/PBCH block index “1” (e.g., and so on and so forth).

For example, flexibility of the symbol rate may result in a highly flexible SSS/PBCH block and/or burst durations. SSS/PBCH bursts may occur in the ith fraction of the frame length, where i<1. For example, SSS/PBCH bursts may occur in a fraction as short as 1/16^{th} of a frame or as long as an entire frame. For example, information regarding which frame fraction the SSS/PBCH block burst occurs within a frame may be conveyed via the PBCH with an appropriate number of bits x, where x=log₂(i). For example, an SSS/PBCH burst may repeat every pre-defined periodicity. Within each burst the WTRU 102 may determine PBCH resources as described herein.

In certain representative embodiments, a WTRU 102 may determine the frame timing by determining which SSS/PBCH block index it has decoded and the frame fraction in which the SSS/PBCH block bursts occurs. For example, SSS/PBCH block offsets from the boundary of the frame fraction may be pre-defined in a specification, such as with respect to the symbol rate and the number of SSS/PBCH blocks. For example, a time offset may be defined as an integer number of symbols, where the symbol duration corresponds to the SSS1 symbol duration, which is a function of the SSS1 symbol rate. For example, a time offset may be defined as an integer number of SC-FDE blocks, where the SC-FDE block may comprise a number of symbols (e.g., equal to the SSS1 duration, or to another integer number) plus a number of CP symbols, if any, with a symbol duration corresponding to the SSS1 symbol duration.

### Other Components and Examples

In certain representative embodiments, a WTRU 102 may detect, measure, and/or synchronize to synchronization signal(s) (e.g., PSS and/or SSS), and/or receive and successfully decode a PBCH. For example, a WTRU 102 may monitor a PDCCH (e.g., based on a decoded PBCH) and subsequently receive a PDSCH scheduled by a received PDCCH (e.g., for reception of system information, paging, random access response, random access message 4, etc.). The WTRU 102 may transmit one or more PRACH, based on the time-and/or frequency synchronization (e.g., incl. DL frame timing) determined from the received synchronization signal(s), on time and/or frequency resources determined from a specification and/or a configuration (e.g., obtained in a received system information message). For example, the WTRU 102 may (e.g., also) transmit a PUSCH (e.g., scheduled by a received PDCCH, such as a random access message 3, random access message A, etc.).

In certain representative embodiments, a WTRU 102 determines a synchronization frequency. The WTRU 102 may determine a set of candidate PSS parameter values. For example, candidate PSS parameter values may include any of candidate PSS sequences, candidate PSS symbol rate, PSS periodicity, and/or other parameter values as described herein. The WTRU 102 may perform PSS detection on the synchronization frequency based on the set of candidate PSS parameter values. The WTRU 102 may determine a set of detected PSSs with corresponding PSS parameter values based on the PSS detection. The WTRU 102 may a PSS for SSS detection (e.g., from the set of detected PSSs). The WTRU 102 may select a set of candidate SSS parameter values. For example, the set may be based on the PSS parameter values of the (e.g., selected) detected PSS. The set of candidate SSS parameters may include any of symbol rate, center frequency, time-domain location, QCL relation with the detected PSS, sequence, and/or other parameters as described herein. A candidate value of a first SSS parameter may be associated with a candidate value of a second SSS parameter, and so forth. For example, a first SSS symbol rate may be associated with a first SSS time-location. The WTRU 102 may perform SSS detection based on the set of candidate SSS parameter values. The WTRU 102 may detect an SSS based on the SSS detection, with corresponding SSS parameter values. The WTRU 102 determines a PBCH resource based on the detected SSS. For example, the WTRU 102 may determine a subset of SSS occasions with PBCH resources. The WTRU 102 may receive and decode a PBCH (e.g., using at least one PBCH resource associated with one of the subset of SSS occasions). Based the decoded PBCH, the WTRU 102 may receive system information (e.g., a MIB). The WTRU 102 may access the cell, based on the system information, such as by performing a random access procedure (e.g., to the cell).

### NUMERICAL EXAMPLES

The following numerical examples are provided to illustrate the synchronization signal overhead in OFDM-based and SC-FDE based systems.

In general, the synchronization signal overhead may be significantly higher in SC-FDE systems, since a narrowband synchronization signal may prevent transmission of other signals over the whole bandwidth for the duration of the synchronization signal transmission. In other words, a narrowband SC-FDE synchronization signal may take a longer time to transmit, due to low symbol rate, while effectively prohibiting any use of the (e.g., whole) wideband channel during this time. In contrast, in OFDM-based systems, other transmissions may be frequency multiplexed during narrowband synchronization signal transmission, thereby reducing the effective overhead of the OFDM-based synchronization signals.

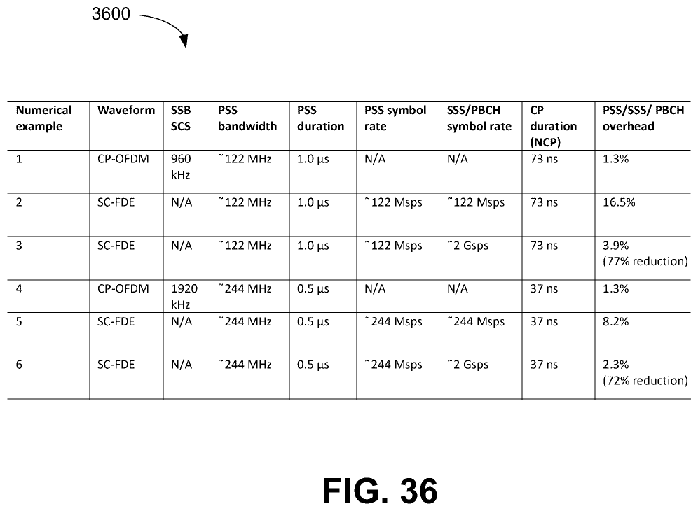

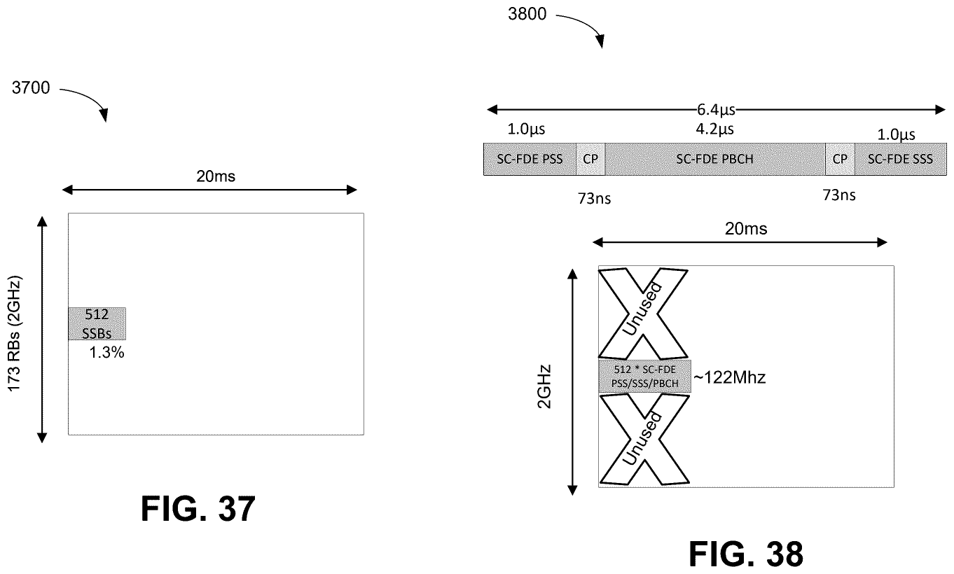

FIG. 36 is a table diagram illustrating comparative examples of waveforms. In the table 3600 in FIG. 36, it can be observed that the synchronization signal overhead in a baseline SC-FDE based system, as in examples 2 and 5, is approximately 6-12 times higher than in a comparable OFDM-based system, as in examples 1 and 4. With the separation of PSS and SSS/PBCH symbol rates, as in examples 3 and 6, the overhead can be reduced by more than 70%. The examples in FIG. 36 are explained in greater detail below and in FIGS. 37 to 41.

For example, considering a high-frequency channel (e.g., sub-THz) with 2 GHz BW and assuming 512 SSB beams (e.g., compared to a max of 64 in NR), 20 ms PSS/SSS/PBCH periodicity, and the same PSS bandwidth and duration in CP-OFDM and SC-FDE.

For NR CP-OFDM systems, one SSB may occupy 20 RBs in 4 OFDM symbols and may, for example, include the following:
PSS: 127-length sequence;
SSS: 127-length sequence; and
PBCH: 432 data resource elements (REs) and 144 DMRS REs.

For SC-FDE systems, synchronization signals may be multiplexed in the time domain and may, for example, include the following:
PSS: 127 symbols+no CP;
SSS: 128 symbols+CP (e.g., with a same CP as CP-OFDM); and
PBCH: 512 symbols+CP (e.g., with a same CP as CP-OFDM).

### Example 1: NR OFDM

FIG. 37 is a time/frequency diagram illustrating a first example 3700 (e.g., Example 1 in FIG. 36) of NR SSB overhead. Assuming a system with a 960 kHz sub-carrier Spacing (SCS) and a corresponding CP duration of approximately 73 ns, as shown in FIG. 37, out of a channel with a 2 GHz BW (e.g., 173 RBs), an NR SSB occupies 230 MHz (e.g., 122 MHz bandwidth for NR PSS). The NR SSB overhead can be calculated as follows:

$$20 ms includes 20 \times 14 \times 26 = 17 , 920 OFDM symbols ;$$

$$512 SSBs present in 512 \times 4 = 2 , 048 OFDM symbols ;$$

$$An SSB occupies \frac{( 20 \times 12 )}{( 173 \times 12 )} = 11.6 \% of the sub - carriers ; and$$

$$NR SSB overhead = \frac{2 , 048}{17 , 920} \times 11.6 \% = 1.3 \% .$$

### Example 2: SC-FDE (122 Msps PSS/SSS/PBCH)

FIG. 38 is a time/frequency diagram illustrating a second example 3800 (e.g., Example 2 in FIG. 36) of SC-FDE overhead. Assuming a SC-FDE PSS, SSS, PBCH symbol rate of 122 Msps (e.g., no symbol rate switching between PSS/PBCH/SSS), as shown in FIG. 38, the PSS/SSS/PBCH overhead can be calculated as follows:

$$Single PSS duration : \frac{127}{122} μ s = 1 μ s ;$$

$$PSS duration : 1 μ s \times 512 beams = 0.53 ms ;$$

$$Single SSS + PBCH duration = 2 \times 0.073 + \frac{( 512 + 128 )}{122} μ s = 5.4 μ s ;$$

$$SSS + PBCH duration = 5.4 μ s \times 512 \approx 2.76 ms ;$$

$$PSS / SSS / PBCH duration = 0.53 + 2.76 \approx 3.3 ms ; and$$

$$SC - FDE PSS / SSS / PBCH overhead = \frac{3.3}{20} = 1 6.5 \% .$$

### Example 3: SC-FDE (122, 2 Gsps SSS/PBCH)

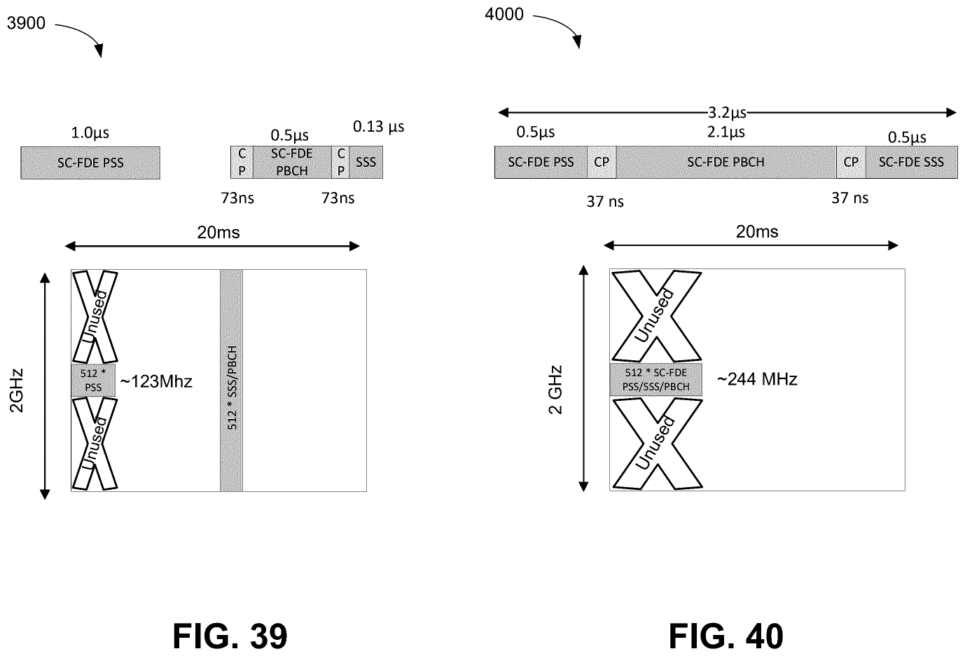

FIG. 39 is a time/frequency diagram illustrating a third example 3900 (e.g., Example 3 in FIG. 36) of SC-FDE overhead. Assuming a SC-FDE PSS symbol rate of 122 Msps and a SSS/PBCH symbol rate of 2 Gsps, as shown in FIG. 39, the PSS/SSS/PBCH overhead can be calculated as follows:
Single PSS duration: 1 μs;

$$PSS duration : 1 μ s \times 512 beams \approx 0.53 ms ;$$

$$Single SSS + PBCH duration = ( 2 \times 73 + \frac{512}{2} + \frac{128}{2} ) ns = 0.47 μ s ;$$

$$SSS + PBCH duration = 0.47 μ s \times 512 \approx 0.24 ms ;$$

$$PSS / SSS / PBCH duration = 0.53 + 0.24 ms \approx 0.77 ms ; and$$

$$SC - FDE PSS / SSS / PBCH overhead = \frac{0.77}{20} = 3.9 \%$$

(e.g., of which 69% comes from PSS and 31% from SSS/PBCH) which is a 77% overhead reduction (e.g., from 16.5%).

### Example 4: NR OFDM

Assuming a NR OFDM system with a 1920 kHz sub-carrier Spacing (SCS) and a corresponding CP duration of approximately 37 ns, out of a channel with a 2 GHz BW (e.g., 87 RBs), a NR PSS occupies 244 MHz bandwidth. The NR SSB overhead (e.g., Example 4 in FIG. 36) can be calculated as follows:

$$20 ms includes 20 \times 14 \times 27 = 38 , 840 OFDM symbols ;$$

$$512 SSBs present in 512 \times 4 = 2 , 048 OFDM symbols ;$$

$$An SSB occupies \frac{( 20 \times 12 )}{( 87 \times 12 )} = 23 \% of the sub - carriers ; and$$

$$NR SSB overhead = \frac{2 , 048}{35 , 820} \times 23 \% = 1.3 \% ( e . g . , same as in example 1 ) .$$

### Example 5: SC-FDE (244 Msps PSS/SSS/PBCH)

FIG. 40 is a time/frequency diagram illustrating a fourth example 4000 (e.g., Example 5 in FIG. 36) of SC-FDE overhead. Assuming a SC-FDE PSS, SSS and PBCH symbol rate of 244 Msps, as shown in FIG. 40, the PSS/SSS/PBCH overhead can be calculated as follows:

$$Single PSS duration : \frac{127}{244} μ s = 0.5 μ s ;$$

$$PSS duration : 0.5 μ s \times 512 beams = 0.27 ms ;$$

$$Single SSS + PBCH duration = 2 \times 0.037 + \frac{( 512 + 128 )}{244} μ s = 2.47 μ s ;$$

$$SSS + PBCH duration = 5.4 μ s \times 512 \approx 1.38 ms ;$$

$$PSS / SSS / PBCH duration = 0.27 + 1.38 \approx 1.65 ms ; and$$

$$SC - FDE PSS / SSS / PBCH overhead = \frac{1.65}{20} = 8.3 \% ( of which 16 \% comes from PSS and 84 \% from SSS / PBCH ) .$$

### Example 6: SC-FDE (244 Msps PSS, 2 Gsps SSS/PBCH)

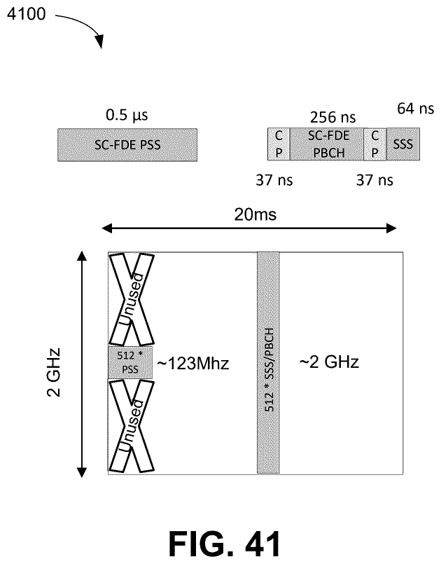

FIG. 41 is a time/frequency diagram illustrating a fifth example 4100 (e.g., Example 6 in FIG. 36) of SC-FDE overhead. Assuming a SC-FDE PSS symbol rate of 244 Msps and a SSS/PBCH symbol rate of 2 Gsps, as shown in FIG. 41, the PSS/SSS/PBCH overhead can be calculated as follows:
Single PSS duration: 0.5 μs;

$$PSS duration : 0.5 μ s \times 512 beams \approx 0.27 ms ;$$

$$Single SSS + PBCH duration = 2 \times 73 + \frac{( 512 + 128 )}{244} ns = 394 n s ;$$

$$SSS + PBCH duration = 394 n s \times 512 \approx 0.2 ms ; and$$

$$PSS / SSS / PBCH duration = 0.27 + 0.2 ms \approx 0.47 ms$$

$$SC - FDE PSS / SSS / PBCH overhead = \frac{0.47}{20} = 2.3 \%$$

(of which 57% comes from PSS and 43% from SSS/PBCH) which leads to a 72% overhead reduction (e.g., from 8.2%)

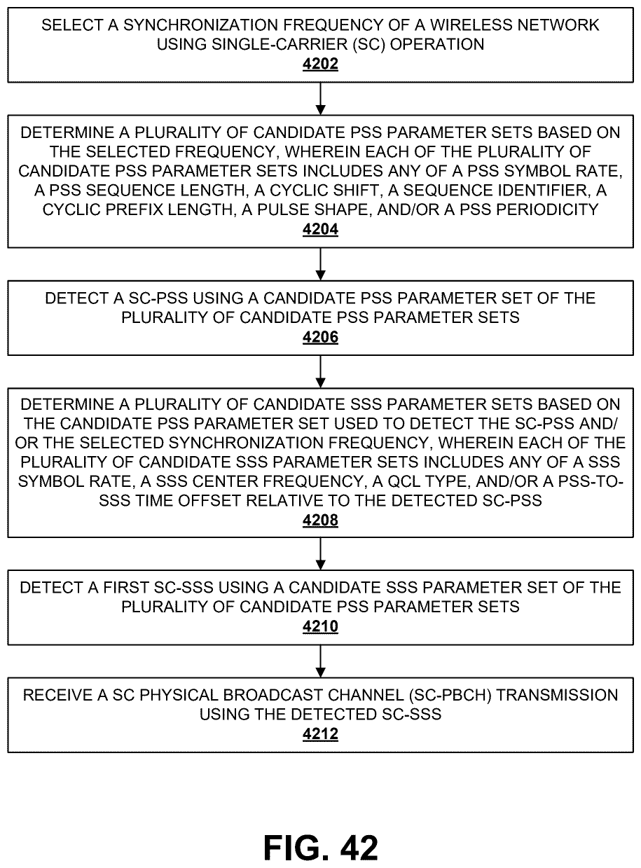

FIG. 42 is a procedural diagram illustrating an example procedure to receive a PBCH transmission. At 4202, a WTRU 102 may select a synchronization frequency of a wireless network using single-carrier (SC) operation (e.g., SC-FDE communications in the DL). At 4204, the WTRU 102 may determine a plurality of candidate PSS parameter sets based on the selected frequency. For example, each of the plurality of candidate PSS parameter sets may (e.g., respectively) include any of a PSS symbol rate, a PSS sequence length, a cyclic shift, a sequence identifier, a cyclic prefix length, a pulse shape, and/or a PSS periodicity. At 4206, the WTRU may detect (e.g., using a SC-FDE receiver 400b) a SC-PSS using a candidate PSS parameter set of the plurality of candidate PSS parameter sets. At 4208, the WTRU may determine a plurality of candidate SSS parameter sets based on the candidate PSS parameter set used to detect the SC-PSS and/or the selected synchronization frequency. For example, each of the plurality of candidate SSS parameter sets may (e.g., respectively) include any of a SSS symbol rate, a SSS center frequency, a quasi collocation (QCL) type, and/or a PSS-to-SSS time offset relative to the detected SC-PSS. At 4210, the WTRU 102 may detect (e.g., using a SC-FDE receiver 400b) a first SC-SSS using a candidate SSS parameter set of the plurality of candidate PSS parameter sets. At 4212, the WTRU 102 may receive (e.g., using a SC-FDE receiver 400b) a SC-PBCH transmission using the detected SC-SSS.

In certain representative embodiments, the WTRU 102 may determine a frequency range and/or band from a set of frequency bands (e.g., SC BWs) of the wireless network. The WTRU 102 may determine a set of candidate synchronization frequencies of the determined frequency range and/or band. For example, the selected synchronization frequency at 4202 may be from the set of candidate synchronization frequencies. For example, the plurality of candidate PSS parameter sets may be associated (e.g., via standard and/or configuration) with the determined frequency range and/or band.

In certain representative embodiments, the WTRU 102 may determine a PBCH resource using a first sequence identifier indicated by the detected first SC-SSS. For example, the SC-PBCH transmission may be received at 4212 using the determined PBCH resource.

In certain representative embodiments, the WTRU 102 may determine the PBCH resource using the first sequence identifier indicated by the detected first SC SSS. For example, the WTRU 102 may determine a second sequence identifier based on the first sequence identifier indicated by the detected first SC-SSS. The WTRU 102 may detect (e.g., using a SC-FDE receiver 400b) a second SC-SSS using (i) any of the SSS symbol rate, the SSS center frequency, the quasi collocation (QCL) type, and/or the PSS-to-SSS time offset of the candidate SSS parameter set used to detect the first SC-SSS and (ii) the second sequence identifier. The WTRU 102 may determine the PBCH resource based on the detected second SC-SSS.

In certain representative embodiments, the SC-PSS and the first SC-SSS in combination may include information indicating a cell identifier, a transmission/reception point (TRP) identifier, and/or a beam identifier. The SC-PSS and the second SC-SSS in combination may include information indicating the (e.g., same) cell identifier, the (e.g., same) TRP identifier, and/or the (e.g., same) beam identifier.

In certain representative embodiments, the first sequence identifier may be associated with a first plurality of sequence identifiers and the second sequence identifier may be associated with a second plurality of sequence identifiers different than the first plurality of sequence identifiers (e.g., subsets, “A” and “B”).

In certain representative embodiments, the WTRU 102 may determine the plurality of candidate SSS parameter sets based on the candidate PSS parameter set used to detect the SC-PSS and the selected synchronization frequency.

In certain representative embodiments, the SC-PBCH transmission may include system information associated with a cell of the wireless network. For example, the WTRU 102 may access the cell based on the system information.

In certain representative embodiments, the PBCH transmission may include information indicating (i) an index of a SSS/PBCH block comprising the detected SC-PSS, the detected first SC-SSS, and the PBCH transmission and/or (ii) a location of the SSS/PBCH block within a frame.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network clement, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
selecting a synchronization frequency of a wireless network using single-carrier (SC) operation;
determining a plurality of candidate primary synchronization signal (PSS) parameter sets based on the selected frequency, wherein each of the plurality of candidate PSS parameter sets includes any of a PSS symbol rate, a PSS sequence length, a cyclic shift, a sequence identifier, a cyclic prefix length, a pulse shape, or a PSS periodicity;
detecting a SC-PSS using a candidate PSS parameter set of the plurality of candidate PSS parameter sets;
determining a plurality of candidate secondary synchronization signal (SSS) parameter sets based on the candidate PSS parameter set used to detect the SC-PSS or the selected synchronization frequency, wherein each of the plurality of candidate SSS parameter sets includes any of a SSS symbol rate, a SSS center frequency, a quasi collocation (QCL) type, or a PSS-to-SSS time offset relative to the detected SC-PSS;
detecting a first SC-SSS using a candidate SSS parameter set of the plurality of candidate PSS parameter sets; and
receiving a SC physical broadcast channel (SC-PBCH) transmission using the detected SC-SSS.

2. The method of claim 1, further comprising:
determining a frequency range or band from a set of frequency bands of the wireless network; and
determining a set of candidate synchronization frequencies of the determined frequency range or band,
wherein the selected synchronization frequency is from the set of candidate synchronization frequencies, and wherein the plurality of candidate PSS parameter sets are associated with the determined frequency range or band.

3. The method of claim 1, further comprising:
determining a PBCH resource using a first sequence identifier indicated by the detected first SC-SSS,
wherein the SC-PBCH transmission is received using the determined PBCH resource.

4. The method of claim 3, wherein the determining the PBCH resource using the first sequence identifier indicated by the detected first SC SSS includes:
determining a second sequence identifier based on the first sequence identifier indicated by the detected first SC-SSS;
detecting a second SC-SSS using (i) any of the SSS symbol rate, the SSS center frequency, the quasi collocation (QCL) type, or the PSS-to-SSS time offset of the candidate SSS parameter set used to detect the first SC-SSS and (ii) the second sequence identifier; and
determining the PBCH resource based on the detected second SC-SSS.

5. The method of claim 4, wherein the SC-PSS and the first SC-SSS in combination include information indicating a first part of any of a cell identifier, a transmission/reception point (TRP) identifier, or a beam identifier, and wherein the SC-PSS and the second SC-SSS in combination include information indicating a second part of the cell identifier, the TRP identifier, or the beam identifier.

6. The method of claim 4, wherein the first sequence identifier is associated with a first plurality of sequence identifiers and the second sequence identifier is associated with a second plurality of sequence identifiers different than the first plurality of sequence identifiers.

7. The method of claim 1, wherein the determining of the plurality of candidate SSS parameter sets is based on the candidate PSS parameter set used to detect the SC-PSS and the selected synchronization frequency.

8. The method of claim 1, wherein the SC-PBCH transmission includes system information associated with a cell of the wireless network.

9. The method of claim 8, further comprising:
accessing the cell based on the system information.

10. The method of claim 1, wherein the PBCH transmission includes information indicating an index of a SSS/PBCH block comprising the detected SC-PSS, the detected first SC-SSS, and the PBCH transmission or a location of the SSS/PBCH block within a frame.

11. A wireless transmit/receive unit (WTRU) comprising:
a processor, memory, and a transceiver which are configured to:
select a synchronization frequency of a wireless network using single carrier (SC) operation,
determine a plurality of candidate primary synchronization signal (PSS) parameter sets based on the selected frequency, wherein each of the plurality of candidate PSS parameter sets includes any of a PSS symbol rate, a PSS sequence length, a cyclic shift, a sequence identifier, a cyclic prefix length, a pulse shape, or a PSS periodicity,
detect a SC-PSS using a candidate PSS parameter set of the plurality of candidate PSS parameter sets,
determine a plurality of candidate secondary synchronization signal (SSS) parameter sets based on the candidate PSS parameter set used to detect the SC-PSS or the selected synchronization frequency, wherein each of the plurality of candidate SSS parameter sets includes any of a SSS symbol rate, a SSS center frequency, a quasi collocation (QCL) type, or a PSS-to-SSS time offset relative to the detected SC-PSS,
detect a first SCSSS using a candidate SSS parameter set of the plurality of candidate PSS parameter sets, and
receive a SC physical broadcast channel (SC-PBCH) transmission using the PBCH resource using the detected SC-SSS.

12. The WTRU of claim 11, wherein the processor, memory, and the transceiver are configured to:
determine a frequency range or band from a set of frequency bands of the wireless network, and
determine a set of candidate synchronization frequencies of the determined frequency range or band,
wherein the selected synchronization frequency is from the set of candidate synchronization frequencies, and wherein the plurality of candidate PSS parameter sets are associated with the determined frequency range or band.

13. The WTRU of claim 11, wherein the processor, memory, and the transceiver are configured to:
determine a PBCH resource using a first sequence identifier indicated by the detected first SC-SSS,
wherein the SC-PBCH transmission is received using the determined PBCH resource.

14. The WTRU of claim 13, wherein the processor, memory, and the transceiver are configured to determine the PBCH resource based on the first sequence identifier indicated by the detected first SC-SSS which includes to:
determine a second sequence identifier based on the first sequence identifier, indicated by the detected first SC-SSS,
detect a second SC-SSS using (i) any of the SSS symbol rate, the SSS center frequency, the QCL type, or the PSS-to-SSS time offset of the candidate SSS parameter set used to detect the first SC-SSS and (ii) the second sequence identifier, and
determine the PBCH resource based on the detected second SC-SSS.

15. The WTRU of claim 14, wherein the SC-PSS and the first SC-SSS in combination include information indicating a first part of any of a cell identifier, a transmission/reception point (TRP) identifier, or a beam identifier, and wherein the SC-PSS and the second SC-SSS in combination include information indicating a second part of the cell identifier, the TRP identifier, or the beam identifier.

16. The WTRU of claim 14, wherein the first sequence identifier is associated with a first plurality of sequence identifiers and the second sequence identifier is associated with a second plurality of sequence identifiers different than the first plurality of sequence identifiers.

17. The WTRU of claim 11, wherein the processor, memory, and the transceiver are configured to determine the plurality of candidate SSS parameter sets based on the candidate PSS parameter set used to detect the SC-PSS and the selected synchronization frequency.

18. The WTRU of claim 11, wherein the SC-PBCH transmission includes system information associated with a cell of the wireless network.

19. The WTRU of claim 18, wherein the processor, memory, and the transceiver are configured to:
access the cell based on the system information.

20. The WTRU of claim 11, wherein the PBCH transmission includes information indicating an index of a SSS/PBCH block comprising the detected SC-PSS, the detected first SC-SSS, and the PBCH transmission or a location of the SSS/PBCH block within a frame.
